(19) United States
(12) Patent Application Publication
(10) Pub. No.: US 2025/0108850 A1
(43) Pub. Date: Apr. 3, 2025

(54) COLLAPSIBLE AND CONVERTIBLE STROLLER WITH ASSOCIATED HANDLE AND FOLDING MECHANISM

(71) Applicant: Britax Child Safety, Inc., Fort Mill, SC (US)

(72) Inventor: Quentin G Walsh, Fort Mill, SC (US)

(21) Appl. No.: 18/897,745

(22) Filed: Sep. 26, 2024

Related U.S. Application Data
(60) Provisional application No. 63/587,616, filed on Oct. 3, 2023.

(51) Int. Cl. B62B 7/06; B62B 9/20

(52) U.S. Cl. CPC B62B 7/064; B62B 9/20

(57) ABSTRACT

A collapsible stroller includes an upper handlebar assembly, a lower handlebar assembly connected to the upper handlebar assembly, a pair of rear leg frames, and a control module. The pair of rear leg frames is pivotally connected with the lower handlebar assembly on a left side and a right side of the stroller, respectively. The control module is configured to extend or retract the upper handlebar assembly in relation to the lower handlebar assembly via a first control mode, and further configured to collapse the pair of rear leg frames with respect to the lower handlebar assembly via a second control mode.

### PRIORITY CLAIM AND CROSS-REFERENCE TO RELATED APPLICATIONS

The present application claims priority to and benefit of U.S. Provisional Patent Application No. 63/587,616 filed Oct. 3, 2023, titled “COLLAPSIBLE AND CONVERTIBLE STROLLER WITH ASSOCIATED HANDLE AND FOLDING MECHANISM,” the disclosure of which is incorporated by reference herein in its entirety and relied upon.

### FIELD

The present disclosure generally relates to children's strollers, and more particularly relates to a collapsible and convertible stroller with an expandable base frame and associated handle, adapters and storage compartment.

### BACKGROUND

Double strollers currently available on the market are designed to convert from a compact single occupant configuration to an expanded double occupant configuration. This convention requires that, when used as a single stroller, the footprint is the same as a double stroller. Double stroller footprints are generally greater than that of dedicated single strollers due to the spacing requirement of two occupant positions. This increase in size makes the stroller more difficult to maneuver in confined space when compared to a dedicated single stroller. Accordingly, there is a need for an improved children's stroller configured to have a frame with an expandable footprint, such that a user of the stroller can have the advantage of a compact size for ease of maneuverability, like a dedicated single stroller, and the option to expand the frame when used in double configuration as needed.

Further, some strollers currently available make use of adapters allowing the connection of different seats and bassinets to be attached to the stroller. These adapters may be lost or misplaced during storage, transportation or use of the stroller. Additionally, it can be challenging and overly confusing to collapse some strollers on the market. Therefore, there is a need for a collapsible stroller that can be easily deployed and collapsed for storage and transportation and address at least the foregoing issues.

### SUMMARY

In light of the disclosure set forth herein, and without limiting the disclosure in any way, in a first aspect of the present disclosure, which may be combined with any other aspect, or portion thereof, a stroller includes a front wheel assembly and a rear wheel assembly. The front wheel assembly includes two front wheels respectively disposed at a left and a right side of the stroller. The rear wheel assembly includes two rear wheels respectively disposed at the left and the right side of the stroller. The front and rear wheels define a footprint of the stroller on a walking surface. The front wheel assembly is configured to be movable relative to the rear wheel assembly with one degree of freedom to change the footprint of the stroller.

In a second aspect of the present disclosure, which may be combined with any other aspect, or portion thereof, the front wheel assembly comprises a first set of attachment components, and the rear wheel assembly comprises a second set of attachment components. The first and second sets of attachment components are configured to move relative to each other with the one degree of freedom to change the footprint of the stroller.

In a third aspect of the present disclosure, which may be combined with any other aspect, or portion thereof, at least one of the first and second sets of attachment components include a rail to allow relative movements between the first and second sets of attachment components.

In a fourth aspect of the present disclosure, which may be combined with any other aspect, or portion thereof, at least one of the first and second sets of attachment components include one or more telescoping components to allow relative movements between the first and second sets of attachment components.

In a fifth aspect of the present disclosure, which may be combined with any other aspect, or portion thereof, at least one of the first and second sets of attachment components include one or more sub-linkage members to allow relative movements between the first and second sets of attachment components.

In a sixth aspect of the present disclosure, which may be combined with any other aspect, or portion thereof, the front wheel assembly comprises a lock/unlock mechanism configured to engage with and disengage from the rear wheel assembly.

In a seventh aspect of the present disclosure, which may be combined with any other aspect, or portion thereof, the front wheel assembly is configured to freely translate to a selected position relative to the rear wheel assembly when the lock/unlock mechanism activates a unlock function.

In an eighth aspect of the present disclosure, which may be combined with any other aspect, or portion thereof, the front wheel assembly is fixed at the selected position when the lock/unlock mechanism activates a lock function.

In a ninth aspect of the present disclosure, which may be combined with any other aspect, or portion thereof, the stroller further includes a basket attached to the front wheel assembly and configured to be movable with the front wheel assembly relative to the rear wheel assembly with the one degree of freedom to change the footprint of the stroller.

In a tenth aspect of the present disclosure, which may be combined with any other aspect, or portion thereof, the stroller further includes a basket detachably placed on the front wheel assembly and configured to be movable with the front wheel assembly relative to the rear wheel assembly with the one degree of freedom to change the footprint of the stroller.

In an eleventh aspect of the present disclosure, which may be combined with any other aspect, or portion thereof, a stroller includes a front wheel assembly and a rear wheel assembly. The rear wheel assembly includes two rear wheels respectively disposed at the left and the right side of the stroller. The front and rear wheels define a footprint of the stroller on a walking surface. The front wheel assembly is configured to be movable relative to the rear wheel assembly with one degree of freedom to change the footprint of the stroller. The front wheel assembly comprises a lock/unlock mechanism configured to engage with and disengage from the rear wheel assembly.

In a twelfth aspect of the present disclosure, which may be combined with any other aspect, or portion thereof, the front wheel assembly includes two front wheels respectively disposed at a left and a right side of the stroller.

In a thirteenth aspect of the present disclosure, which may be combined with any other aspect, or portion thereof, the front wheel assembly comprises a first set of attachment components. The rear wheel assembly comprises a second set of attachment components, wherein the first and second sets of attachment components are configured to move relative to each other with the one degree of freedom to change the footprint of the stroller.

In a fourteenth aspect of the present disclosure, which may be combined with any other aspect, or portion thereof, at least one of the first and second sets of attachment components include a rail to allow relative movements between the first and second sets of attachment components.

In a fifteenth aspect of the present disclosure, which may be combined with any other aspect, or portion thereof, at least one of the first and second sets of attachment components include one or more telescoping components to allow relative movements between the first and second sets of attachment components.

In a sixteenth aspect of the present disclosure, which may be combined with any other aspect, or portion thereof, at least one of the first and second sets of attachment components include one or more sub-linkage members to allow relative movements between the first and second sets of attachment components.

In a seventeenth aspect of the present disclosure, which may be combined with any other aspect, or portion thereof, the front wheel assembly is configured to freely translate to a selected position relative to the rear wheel assembly when the lock/unlock mechanism activates a unlock function.

In an eighteenth aspect of the present disclosure, which may be combined with any other aspect, or portion thereof, the front wheel assembly is fixed at the selected position when the lock/unlock mechanism activates a lock function.

In a nineteenth aspect of the present disclosure, which may be combined with any other aspect, or portion thereof, the stroller further includes a basket attached to the front wheel assembly and configured to be movable with the front wheel assembly relative to the rear wheel assembly with the one degree of freedom to change the footprint of the stroller.

In a twentieth aspect of the present disclosure, which may be combined with any other aspect, or portion thereof, the stroller further includes a basket detachably placed on the front wheel assembly and configured to be movable with the front wheel assembly relative to the rear wheel assembly with the one degree of freedom to change the footprint of the stroller.

In a twenty-first aspect of the present disclosure, which may be combined with any other aspect, or portion thereof, a collapsible stroller includes an upper handlebar assembly, a lower handlebar assembly, a pair of rear leg frames, and a control module. The lower handlebar assembly is connected to the upper handlebar assembly. The pair of rear leg frames is pivotally connected with the lower handlebar assembly on a left side and a right side of the stroller, respectively. The control module is configured to extend or retract the upper handlebar assembly in relation to the lower handlebar assembly via a first control mode, and further configured to collapse the pair of rear leg frames with respect to the lower handlebar assembly via a second control mode.

In a twenty-second aspect of the present disclosure, which may be combined with any other aspect, or portion thereof, the upper handlebar assembly includes a generally U-shaped handle portion and two tubular members extend axially downward from two side portions of the U-shaped handle portion.

In a twenty-third aspect of the present disclosure, which may be combined with any other aspect, or portion thereof, the lower handlebar assembly includes two tubular leg members configured to respectively receive the two tubular members of the upper handlebar assembly.

In a twenty-fourth aspect of the present disclosure, which may be combined with any other aspect, or portion thereof, a distal end of each tubular member of the upper handlebar assembly is connected with a sub-assembly. The sub-assembly includes a first component configured to control relative movements between the upper and lower handlebar assemblies, and a second component configured to collapse the pair of rear leg frames with respect to the lower handlebar assembly.

In a twenty-fifth aspect of the present disclosure, which may be combined with any other aspect, or portion thereof, each tubular leg member of the lower handlebar assembly includes a plurality of holes configured to engage with the first component and the second component.

In a twenty-sixth aspect of the present disclosure, which may be combined with any other aspect, or portion thereof, in response to detecting that the first control mode is activated, the control module is configured to move the first component into an unlocked position, such that the upper handlebar assembly moves relative to the lower handlebar assembly.

In a twenty-seventh aspect of the present disclosure, which may be combined with any other aspect, or portion thereof, the first control mode is deactivated when the first component engage with one of the plurality of holes on each tubular leg member of the lower handlebar assembly, thereby locking the upper handlebar assembly to the lower handlebar assembly at a selected position.

In a twenty-eighth aspect of the present disclosure, which may be combined with any other aspect, or portion thereof, in response to detecting that the first component is engaged with a lowest hole on each tubular leg member of the lower handlebar assembly and the second control mode is activated, the control module is configured to force the second component to project out the lowest hole in order to unlock a hinge associated with the pair of rear leg frames.

In a twenty-ninth aspect of the present disclosure, which may be combined with any other aspect, or portion thereof, the hinge is activated to allow the pair of rear leg frames to pivot about a connection component coupled with the lower handlebar assembly, thereby collapsing the pair of rear leg frames with respect to the lower handlebar assembly.

In a thirtieth aspect of the present disclosure, which may be combined with any other aspect, or portion thereof, the second control mode of the control module only activates when the first component is engaged with the lowest hole on each tubular leg member of the lower handlebar assembly.

In a thirty-first aspect of the present disclosure, which may be combined with any other aspect, or portion thereof, a collapsible stroller includes an upper handlebar assembly, a lower handlebar assembly, a pair of rear leg frames, and a control module. The lower handlebar assembly is connected to the upper handlebar assembly. The pair of rear leg frames is pivotally connected with the lower handlebar assembly on a left side and a right side of the stroller, respectively. The control module has a first button and a second button, the control module configured to extend or retract the upper handlebar assembly in relation to the lower handlebar assembly via a the first button.

In a thirty-second aspect of the present disclosure, which may be combined with any other aspect, or portion thereof, the upper handlebar assembly includes a generally U-shaped handle portion and two tubular members extend axially downward from two side portions of the U-shaped handle portion.

In a thirty-third aspect of the present disclosure, which may be combined with any other aspect, or portion thereof, the lower handlebar assembly includes two tubular leg members configured to respectively receive the two tubular members of the upper handlebar assembly.

In a thirty-fourth aspect of the present disclosure, which may be combined with any other aspect, or portion thereof, a distal end of each tubular member of the upper handlebar assembly is connected with a sub-assembly. The sub-assembly includes a first component configured to control relative movements between the upper and lower handlebar assemblies, and a second component configured to collapse the pair of rear leg frames with respect to the lower handlebar assembly.

In a thirty-fifth aspect of the present disclosure, which may be combined with any other aspect, or portion thereof, each tubular leg member of the lower handlebar assembly includes a plurality of holes configured to engage with the first component and the second component.

In a thirty-sixth aspect of the present disclosure, which may be combined with any other aspect, or portion thereof, in response to detecting that the first button is activated, the control module is configured to move the first component into an unlocked position, such that the upper handlebar assembly moves relative to the lower handlebar assembly.

In a thirty-seventh aspect of the present disclosure, which may be combined with any other aspect, or portion thereof, the first button is deactivated when the first component engage with one of the plurality of holes on each tubular leg member of the lower handlebar assembly, thereby locking the upper handlebar assembly to the lower handlebar assembly at a selected position.

In a thirty-eighth aspect of the present disclosure, which may be combined with any other aspect, or portion thereof, the collapsible stroller is further configured to collapse the pair of rear leg frames with respect to the lower handlebar assembly via the second button. In response to detecting that the first component is engaged with a lowest hole on each tubular leg member of the lower handlebar assembly and the second button is activated, the control module is configured to force the second component to project out the lowest hole in order to unlock a hinge associated with the pair of rear leg frames.

In a thirty-ninth aspect of the present disclosure, which may be combined with any other aspect, or portion thereof, the hinge is activated to allow the pair of rear leg frames to pivot about a connection component coupled with the lower handlebar assembly, thereby collapsing the pair of rear leg frames with respect to the lower handlebar assembly.

In a fortieth aspect of the present disclosure, which may be combined with any other aspect, or portion thereof, the second button of the control module only activates when the first component is engaged with the lowest hole on each tubular leg member of the lower handlebar assembly.

In a forty-first aspect of the present disclosure, which may be combined with any other aspect, or portion thereof, a purpose-built storage compartment of a stroller includes a compartment housing configured to be fitted into a selected position of a stroller, a cover, and a pair of adapters configured to pivotally connect with the compartment housing and be movable between a storage position inside the compartment housing and a deployed position to engage with a detachable apparatus.

In a forty-second aspect of the present disclosure, which may be combined with any other aspect, or portion thereof, the cover is made of a transparent material, an opaque material, or a semi-transparent material.

In a forty-third aspect of the present disclosure, which may be combined with any other aspect, or portion thereof, the compartment housing is made of a flexible and soft material.

In a forty-fourth aspect of the present disclosure, which may be combined with any other aspect, or portion thereof, the compartment housing is made of a rigid material.

In a forty-fifth aspect of the present disclosure, which may be combined with any other aspect, or portion thereof, the pair of adapters are integrated with the compartment housing.

In a forty-sixth aspect of the present disclosure, which may be combined with any other aspect, or portion thereof, the pair of adapters are releasably attached to the compartment housing.

In a forty-seventh aspect of the present disclosure, which may be combined with any other aspect, or portion thereof, the compartment housing is fitted into a front side of the stroller adjacent to two front wheels of the stroller.

In a forty-eighth aspect of the present disclosure, which may be combined with any other aspect, or portion thereof, the detachable apparatus includes at least one of a child stroller seat, a child safety seat, a pram, a bassinet, or a storage component.

In a forty-ninth aspect of the present disclosure, which may be combined with any other aspect, or portion thereof, the pair of adapters are configured to be in the deployed position to receive the detachable apparatus in a forward facing position.

In a fiftieth aspect of the present disclosure, which may be combined with any other aspect, or portion thereof, the pair of adapters are configured to be in the deployed position to receive the detachable apparatus in a rearward facing position.

In a fifty-first aspect of the present disclosure, which may be combined with any other aspect, or portion thereof, an adapter assembly of a stroller includes a connection member, an elongated body, and a mounting fixture. The connection member is configured to engage with a detachable apparatus in different orientations. The elongated body is connected with and extended from the connection member. The mounting fixture includes a first channel configured to receive the elongated body and a second channel configured to attach the adapter assembly to a selected position on a side frame of the stroller.

In a fifty-second aspect of the present disclosure, which may be combined with any other aspect, or portion thereof, the connection member and the elongated body are integrally formed.

In a fifty-third aspect of the present disclosure, which may be combined with any other aspect, or portion thereof, the connection member and the elongated body are releasably attached to each other.

In a fifty-fourth aspect of the present disclosure, which may be combined with any other aspect, or portion thereof, the elongated body extends along an axis generally parallel to the side frame of the stroller.

In a fifty-fifth aspect of the present disclosure, which may be combined with any other aspect, or portion thereof, the elongated body is configured to move relative to the first channel of the mounting fixture along the axis to provide multiple position levels of the detachable apparatus.

In a fifty-sixth aspect of the present disclosure, which may be combined with any other aspect, or portion thereof, the multiple position levels of the detachable apparatus are provided as a function of a vertical distance between the connection member and the mounting fixture.

In a fifty-seventh aspect of the present disclosure, which may be combined with any other aspect, or portion thereof, the adapter assembly further includes locking mechanisms configured to maintain the connection member at each of the multiple position levels.

In a fifty-eighth aspect of the present disclosure, which may be combined with any other aspect, or portion thereof, the locking mechanisms comprise components implemented on at least one of an outer surface of the elongated body and an interior surface of the first channel to minimize or prevent relative movements therebetween when the detachable apparatus is installed at one of the multiple position level.

In a fifty-ninth aspect of the present disclosure, which may be combined with any other aspect, or portion thereof, an adapter is attached and secured to an opposite side of the side frame of the stroller to collectively receive the detachable apparatus.

In a sixtieth aspect of the present disclosure, which may be combined with any other aspect, or portion thereof, a thickness of the elongated body is at least equal to that of the side frame.

In a sixty-first aspect of the present disclosure, which may be combined with any other aspect, or portion thereof, a releasable adapter assembly of a stroller includes a pair of releasable adapters. Each adapter includes an engagement member extending upward to engage with a detachable apparatus, a member configured to lock/unlock each adapter to a set of mounting fixtures installed on selected positions on two tubular leg members of a lower handlebar assembly of the stroller, and a linkage member configured to couple the engagement member to the member.

In a sixty-second aspect of the present disclosure, which may be combined with any other aspect, or portion thereof, the linkage member has a substantially dogleg shape including a vertical part and an extension part that is at an angle to the vertical part.

In a sixty-third aspect of the present disclosure, which may be combined with any other aspect, or portion thereof, a length of the vertical part is selected to position the detachable apparatus in an elevated position without interfering with other parts of the stroller.

In a sixty-fourth aspect of the present disclosure, which may be combined with any other aspect, or portion thereof, a length of the extension part and an angle between the vertical part and the extension part is configured to provide a horizontal positioning adjustment to the detachable apparatus.

In a sixty-fifth aspect of the present disclosure, which may be combined with any other aspect, or portion thereof, the angle between the vertical part and the extension part is more than 90 degrees but less than 180 degrees.

Still other embodiments will become readily apparent to those skilled in the art from the following detailed description, wherein are described embodiments by way of illustrating the best mode contemplated. As will be realized, other and different embodiments are possible and the embodiments' several details are capable of modifications in various obvious respects, including time and clustering of events, all without departing from their spirit and the scope. Accordingly, the drawings and detailed description are to be regarded as illustrative in nature and not as restrictive.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a child stroller in a single occupant configuration, according to an exemplary aspect of the present disclosure.

FIG. 2 illustrates a child stroller in a double occupant configuration, according to an exemplary aspect of the present disclosure.

FIG. 3 illustrates that the child stroller of FIGS. 1 and 2 has an expandable footprint, according to an exemplary aspect of the present disclosure.

FIGS. 4A to 4F illustrate various perspective views of an expandable base frame of a child stroller, according to an exemplary aspect of the present disclosure.

FIGS. 4G to 4N illustrate various perspective views of a lock/unlock mechanism implemented on a front wheel assembly of a child stroller to engage with, or disengage from, a rear wheel assembly of the child stroller, according to an exemplary aspect of the present disclosure.

FIGS. 5A to 5D illustrate various perspective views of a purpose-built storage compartment of a child stroller, according to an exemplary aspect of the present disclosure.

FIGS. 6A to 6C illustrate a releasable adapter assembly, according to an exemplary aspect of the present disclosure.

FIG. 7A illustrates a releasable adapter assembly placed on a lower front position on a child stroller, according to an exemplary aspect of the present disclosure.

FIG. 7B illustrates a releasable adapter assembly placed on a higher rear position on a child stroller, according to an exemplary aspect of the present disclosure.

FIGS. 7C to 7F illustrate various perspective views of the releasable adapter assembly of FIGS. 7A and 7B, according to an exemplary aspect of the present disclosure.

FIGS. 7G to 7K illustrate various perspective views of another releasable adapter assembly, according to an exemplary aspect of the present disclosure.

FIG. 8A illustrates an adapter assembly extending upward along an axis parallel to a side frame of a child stroller to place a detachable apparatus at a highest position near a handle portion of the child stroller, according to an exemplary aspect of the present disclosure.

FIG. 8B illustrates an adapter assembly extending downward along an axis parallel to a side frame of a child stroller to place a detachable apparatus at a lowest position near a front end of the child stroller, according to an exemplary aspect of the present disclosure.

FIGS. 8C to 8E illustrate various components of the adapter assembly of FIGS. 8A and 8B, according to an exemplary aspect of the present disclosure.

FIGS. 9A to 9C illustrate how a user folds an upper handlebar assembly of a child stroller as a first step to collapse the child stroller, according to an exemplary aspect of the present disclosure.

FIGS. 10A to 10C illustrate how a user folds a frame of a child stroller as a second step to collapse the child stroller, according to an exemplary aspect of the present disclosure.

FIG. 11 illustrates a control module implemented on a handle grip of a child stroller, according to an exemplary aspect of the present disclosure.

FIGS. 12A to 12B illustrate an upper handlebar assembly of a child stroller telescoped in and out, respectively, according to an exemplary aspect of the present disclosure.

FIGS. 13A to 13B illustrate an upper handlebar assembly of a child stroller, according to an exemplary aspect of the present disclosure.

FIG. 14 illustrates an lower handlebar assembly of a child stroller, according to an exemplary aspect of the present disclosure.

FIG. 15 illustrates an assembled view of the upper and lower handlebar assemblies, according to an exemplary aspect of the present disclosure.

FIG. 16 illustrates a tubular leg member of the lower handlebar assembly of FIG. 14, according to an exemplary aspect of the present disclosure.

FIG. 17 illustrates functionality of the upper handlebar assembly of FIGS. 13A to 13B locking into the lower handlebar assembly of FIG. 14 at a selected position, according to an exemplary aspect of the present disclosure.

FIG. 18 illustrates functionality of the upper handlebar assembly of FIGS. 13A to 13B moving inside the lower handlebar assembly of FIG. 14, according to an exemplary aspect of the present disclosure.

FIG. 19 illustrates a component implemented on the upper handlebar assembly of FIGS. 13A to 13B, according to an exemplary aspect of the present disclosure.

FIG. 20 illustrates unactuated states of the control module of FIG. 11 and the upper handlebar assembly of FIGS. 13A to 13B, according to an exemplary aspect of the present disclosure.

FIG. 21 illustrates functionality of a first button of the control module of FIG. 11, when actuated, controlling the upper handlebar assembly of FIGS. 13A to 13B, according to an exemplary aspect of the present disclosure.

FIG. 22 illustrates functionality of first and second buttons of the control module of FIG. 11, when both actuated, controlling the upper handlebar assembly of FIGS. 13A to 13B, according to an exemplary aspect of the present disclosure.

FIGS. 23A to 23B illustrate how to collapse a frame of a child stroller, according to an exemplary aspect of the present disclosure.

FIGS. 24A to 24B illustrate a first folding structure of a child stroller, according to an exemplary aspect of the present disclosure.

FIGS. 25A to 25C illustrate detailed views of the first folding structure, according to an exemplary aspect of the present disclosure.

FIGS. 26A to 26B illustrate a second folding structure of a child stroller, according to an exemplary aspect of the present disclosure.

FIG. 27 illustrates a first portion of the second folding structure, according to an exemplary aspect of the present disclosure.

FIG. 28 illustrates a second portion of the second folding structure, according to an exemplary aspect of the present disclosure.

FIG. 29 illustrates the second folding structure pivoting to a first position, according to an exemplary aspect of the present disclosure.

FIG. 30 illustrates the second folding structure pivoting to a second position, according to an exemplary aspect of the present disclosure.

### DETAILED DESCRIPTION

Various aspects of present disclosure will be described with reference to the drawings, wherein like reference numerals are used to refer to like elements throughout. In the following description, for purposes of explanation, numerous specific details are set forth in order to promote a thorough understanding of one or more aspects of the present disclosure. It may be evident in some or all instances, however, that any aspects described below can be practiced without adopting the specific design details described below.

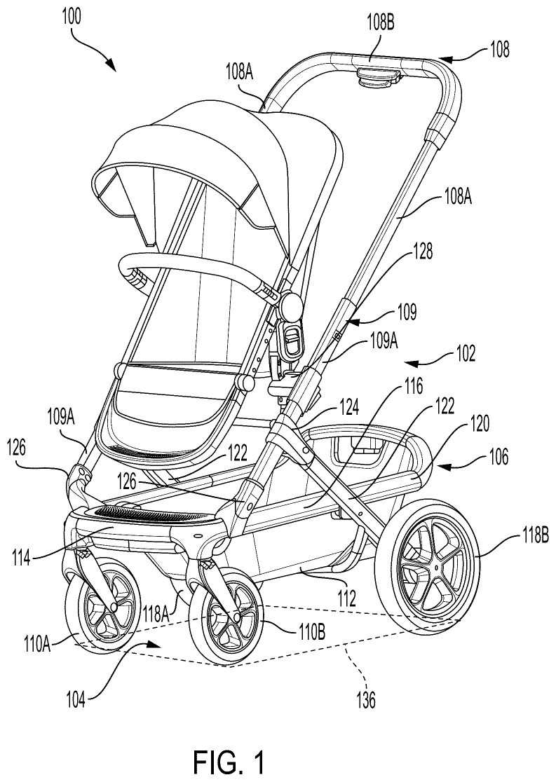

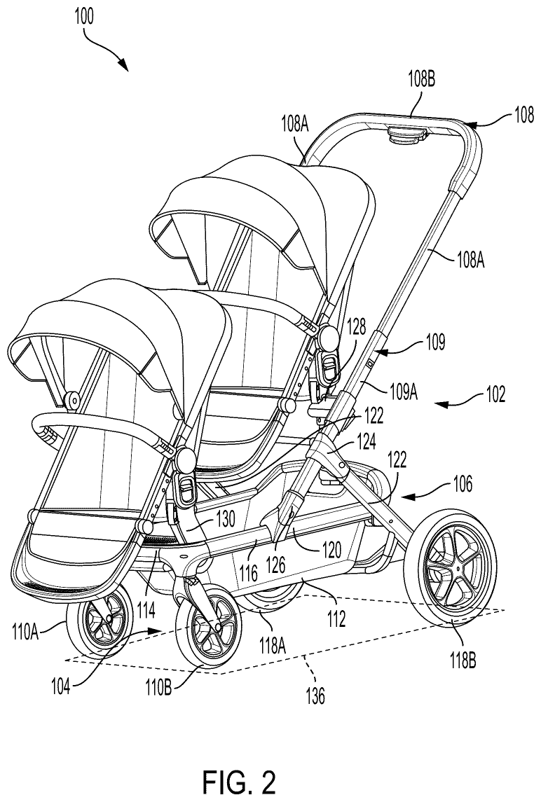

Referring to FIGS. 1 and 2, in accordance with aspects of the present disclosure, a child stroller 100 may be converted from a single occupant configuration (illustrated by FIG. 1) to a double occupant configuration (illustrated by FIG. 2). The child stroller 100 may comprise a collapsible stroller frame 102 which may generally include a front wheel assembly 104 and a rear wheel assembly 106. The front wheel assembly 104 may include two front wheels 110A, 110B respectively disposed at a left and a right side of the child stroller 100. While front wheel assembly 104 is illustrated with two wheels, it should be appreciated that in an alternate embodiment front wheel assembly 104 could have a different number of wheels, such as one wheel at a center point.

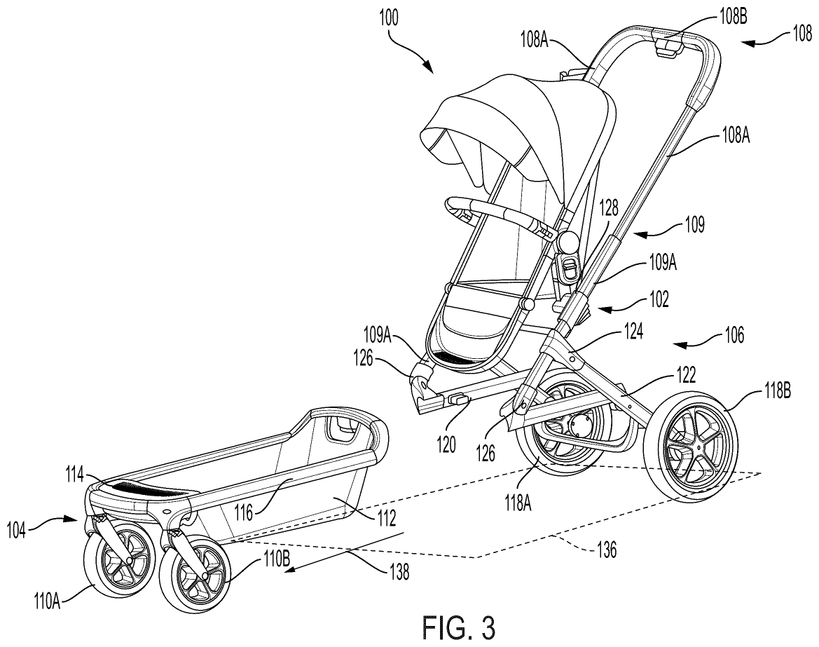

Child stroller 100 further includes a basket 112 positioned at the bottom of the child stroller 100, a purpose-built storage compartment 114, attachment component(s) 116, and lock/unlock features that permit translating or sliding the front wheel assembly 104 relative to the rear wheel assembly 106, as illustrated in FIG. 3. As will be described fully below, in some embodiments, the adaptors 130 stored in the purpose-built storage compartment 114, as shown in FIG. 2, may be utilized to receive a detachable apparatus, thereby converting the child stroller 100 from a single occupant configuration to a double occupant configuration.

Child stroller 100 includes the rear wheel assembly 106, which may include two rear wheels 118A, 118B respectively disposed at a left and a right side of the child stroller 100. Rear wheel assembly 106 may further include attachment component(s) 120. Child stroller 100 includes an upper handlebar assembly 108, a lower handlebar assembly 109, and a pair of rear leg frames 122 on both sides of the stroller 100. The upper handlebar assembly 108 may include two parallel tubular members 108A connected with a handle grip 108B. The pair of tubular members 108A extend axially downward to insert into corresponding tubular leg members 109A of the lower handlebar assembly 109, respectively. Alternatively, it should be appreciated that tubular leg members 109A could be insertable into the pair of tubular members 108A.

A distal end of each rear leg frame 122 of the rear wheel assembly 106 may be pivotally connected with each tubular leg member 109A of the lower handlebar assembly 109 via a first connection component 124. Further, a distal end of each tubular leg member 109A may be pivotally connected with the front wheel assembly 104 via a second connection component 126. As will be described fully below, the upper handlebar assembly 108 may be configured to be extendable and retractable in relation to the lower handlebar assembly 109. Further, the rear leg frames 122 of the rear wheel assembly 106 may be configured to rotate relative to tubular leg members 109A of the lower handlebar assembly 109 via the connection component 124. As a result, the rear leg frames 122 of the rear wheel assembly 106, the upper handlebar assembly 108, and the lower handlebar assembly 109 may be movably coupled to one another for implementing folding and unfolding of the child stroller 100.

Referring to FIGS. 1 to 3, in addition to the aforementioned adaptors 130, the child stroller 100 also includes an adapter assembly 128 configured to receive the installation of a detachable apparatus at a higher rear position on the child stroller 100. Example detachable apparatuses that may be installed on both adapters 128 and 130 include detachable child seats such as child stroller seats and child safety seats, prams, bassinets, storage components such as baskets, and the like. Each adaptor 128, 130 may include a coupling portion configured to receive the engagement of the detachable apparatus in various orientations. For example, a detachable child seat may be engaged with the coupling portion of each adaptor 128, 130 in order to be installed in either a forward facing position or a rearward facing position.

In certain embodiments, the adapter assembly 128 may be configured to be releasably attached to the lower handlebar assembly 109. In some other embodiments, the adapter assembly 128 may be configured to slide upward and downward along a rail implemented on both side portions of the lower handlebar assembly 109. Such a rail (not shown) may extend between the connection component 124 and the upper end of the lower handlebar assembly 109. The coupling portions of each adapter may be protruding upward during use and the sliding axis of each adapter may be supported by and parallel to tubular leg members 109A of the lower handlebar assembly 109. The detachable apparatus mounted on the adapter assembly 128 may move along the rail upward and downward in unison with the adapter assembly 128 for adjustment between various positions.

In other embodiments, the adapter assembly 128 may be permanently affixed to the lower handlebar assembly 109, such that it cannot be manually removed from the lower handlebar assembly 109 without tools. Whether releasably attached or permanently affixed, in certain embodiments, the lower handlebar assembly 109 can be rotated, pivoted, hinged, or otherwise moved between a usage position to an unused/storage position, as described in greater detail herein.

### Single to Double Convertible Stroller With an Expandable Base Frame

Referring to FIG. 3, in accordance with aspects of the present disclosure, the child stroller 100 may be converted from a single occupant configuration (FIG. 1) to a double occupant configuration (FIG. 2) with an enlarged footprint at the base of the child stroller 100. That is, by having a base frame with an expandable footprint, a user of the child stroller 100 is provided with the advantage of a compact size for ease of maneuverability, like a dedicated single stroller, and the option to expand the base when used in the double occupant configuration and/or when additional storage is necessary. As shown in FIGS. 1 and 2, in one aspect, the front wheels 110A, 110B and rear wheels 118A, 118B may generally form a footprint 136 of the child stroller 100 on a walking surface. The expandable frame at the base of the child stroller 100 allows the user to manipulate the size of the stroller footprint into multiple configurations ranging from an initial default footprint 136 to a maximum footprint and multiple footprint sizes (expanding in the direction of the arrow 138 (i.e., forward moving direction of the child stroller 100)), depending on the desired use and configuration.

To prevent tipping, it is important to maintain the center of the gravity (CG) of the child stroller 100 above its support base (i.e., footprint). The CG location may generally refer to the average location of all the weight of the child stroller 100. In other words, the CG is the balance point of the child stroller 100 and a theoretical point at which the total weight of the child stroller is deemed to be concentrated. Typically, the lower the CG is to the ground, the more balanced and stable the child stroller 100 will be. When the child stroller 100 changes between single occupant and double occupant configurations, the CG location varies. As shown in FIG. 2, the present disclosure increases the footprint of the child stroller 100 by increasing the distance between the front and rear wheels 110A, 110B, 118A, and 118B, thereby increasing the wheelbase of the child stroller 100 to accommodate a dual occupant configuration and a change of CG location in order to improve the stability and prevent tipping.

For illustrative purposes only, FIG. 3 shows front and rear wheel assemblies 104, 106 that are disassembled and detached from each other. It should be understood that the rear wheel assembly 106 is coupled to the front wheel assembly 104 in such a manner that there is one degree of freedom: allowing the front wheel assembly 104 to be translated relative to rear wheel assembly 106, to increase or decrease the footprint 136 of the child stroller 100. In one preferred embodiment, the rear wheel assembly 106 may have two parallel attachment components 120 respectively disposed at a left and a right side of the child stroller 100. The attachment components 120 may be configured to connect with the corresponding attachment components 116 of the front wheel assembly 104 to form an expandable base frame of the child stroller 100.

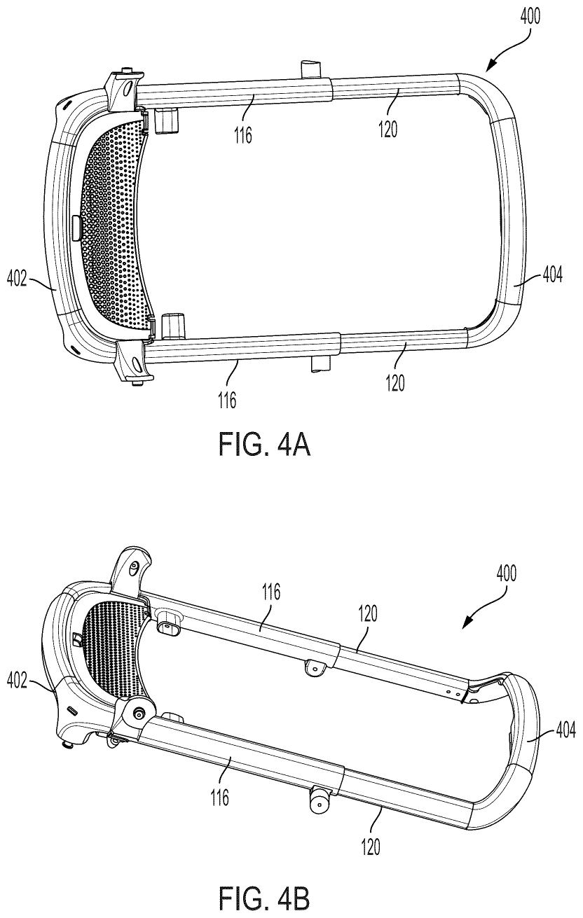

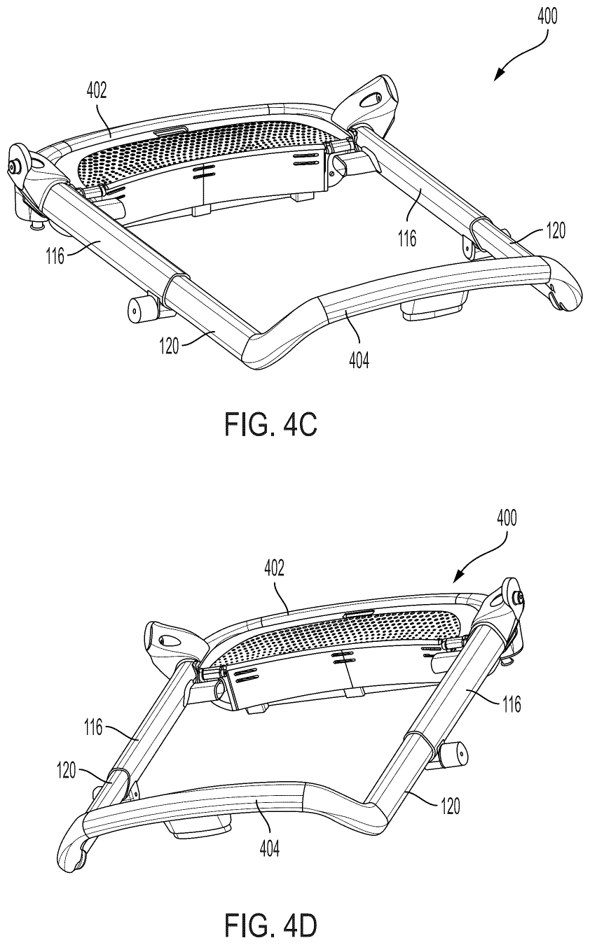

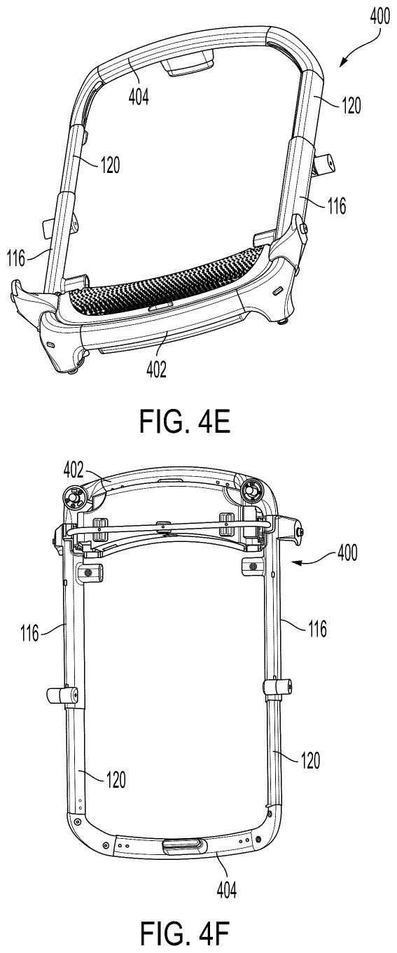

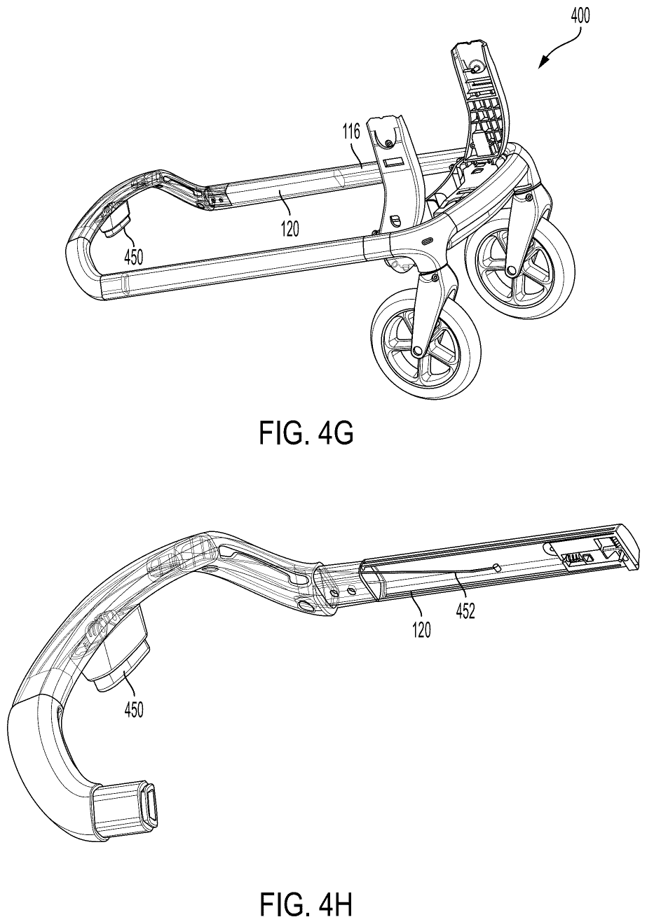

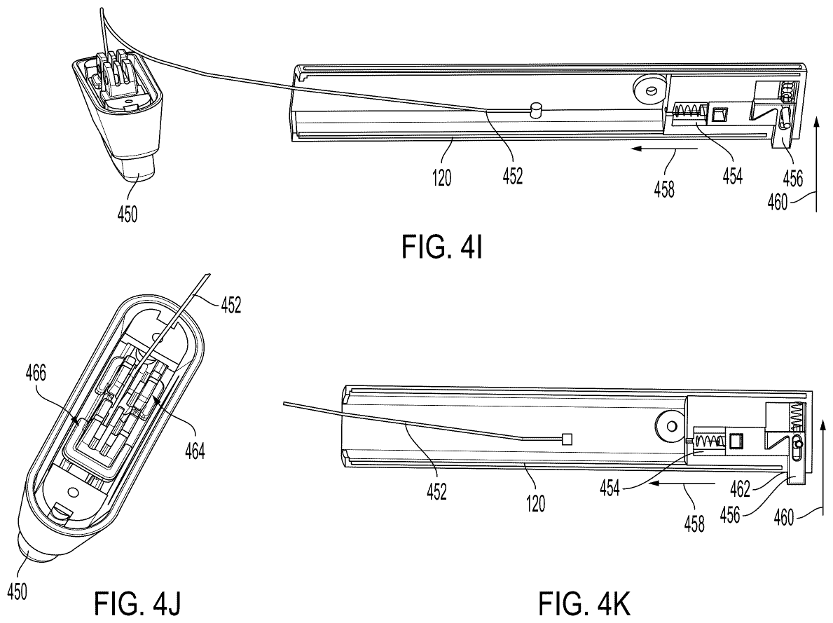

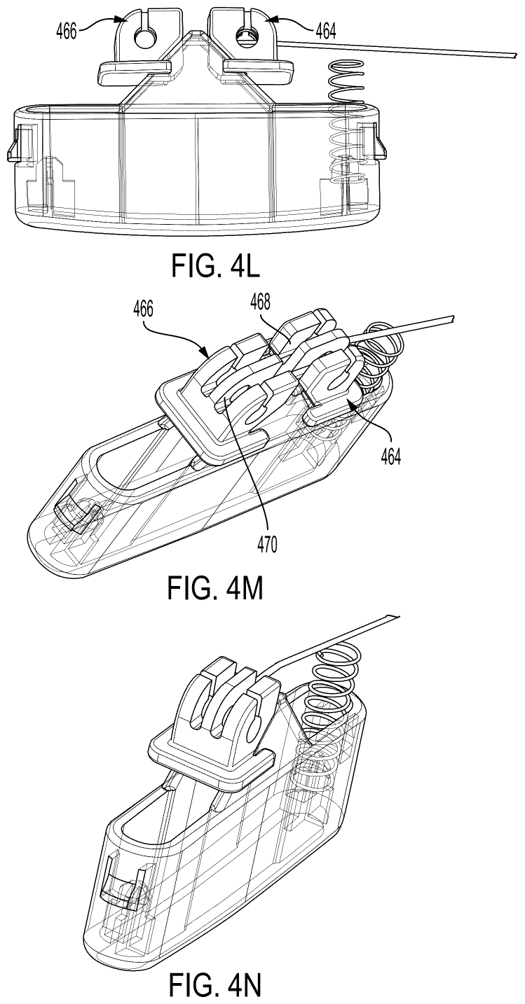

FIGS. 4A to 4F illustrate various perspective views of an expandable base frame 400 of the child stroller 100, in accordance with aspects of the present disclosure. The base frame 400 may be generally rectangular shaped including two side portions connecting a front portion 402 and a back portion 404. Each side portion is composed of an attachment component or linkage member 116 of the front wheel assembly 104 and an attachment component or linkage member 120 of the rear wheel assembly 106. To adjust the distance between the front wheels 110A, 110B and the rear wheels 118A, 118B and expand the overall footprint 136 of the child stroller 100, attachment members 116 and 120 translate relative to one another. For example, rails may be implemented on either or both attachment components 116, 120 to allow sliding movements therebetween. FIGS. 4A to 4F illustrate that the attachment components 120 fit and slide into the attachment components 116 of the front wheel assembly 104. In an alternative embodiment, the attachment components 116 can fit and slide inside the attachment components 120. In yet another embodiment, either or both attachment components 116, 120 may include one or more telescoping components and sub-linkage members to allow extension and retraction of the base frame 400 of the child stroller 100. In one aspect, the maximum distance between the front wheels 110A, 110B and the rear wheels 118A, 118B footprint that can be achieved may be defined by the total length of both attachment components 116, 120 in their fully extended states. It should be appreciated that attachment components 116, 120 may be connected by any suitable means to facilitate parallel axial movements therebetween, such as screws, brackets, welds, pins, rails, slots, and slides. Attachment components 116 and 120 can be made of metal, plastic, or any other similarly suitable material.

Referring to FIGS. 4G to 4K, a lock/unlock mechanism may be implemented on the front wheel assembly 104 to engage with or disengage it from the rear wheel assembly 106. It should be appreciated that the design, construction and operation of the lock/unlock mechanism may be symmetrically implemented on both sides of the child stroller 100 or, alternatively, on only one side of child stroller 100. For the sake of brevity, only one side is shown in details in FIGS. 4H to 4K. The lock/unlock mechanism may be achieved by use of a button 450 controlled by the user of the child stroller 100. When the user disengages the lock mechanism, such as actuating the button 450, the front wheel assembly 104 is free to translate to a desired pre-set position relative to the rear wheel assembly 106. When the lock mechanism is reengaged at the pre-set position, the relative position between the front and rear wheel assembles 104, 106 becomes fixed and can no longer translate relative to each other.

In one preferred embodiment, as shown in FIGS. 4G and 4H, attachment components 120 may include two tubular members disposed on both sides of the child stroller 100 that are inserted into corresponding tubular members of attachment components 116, respectively. At the distal end of each tubular member of attachment components 120, a sub-assembly may control a telescoping distance between the attachment components 116, 120 in order to facilitate the extension and retraction of the base frame 400 of the child stroller 100 when the button 450 is actuated.

Namely, referring to FIG. 4I, the button 450 may be coupled to each sub-assembly of the attachment component 120 via a cable connection 452. The distal end of each sub-assembly includes a cam 454 and a component 456 for adjusting the telescoping distance between the attachment components 116, 120. When the button 450 is actuated, referring to FIGS. 4I and 4K, an internal cable pulls the cam 454 of each sub-assembly, which is spring biased, in the direction of the arrow 458. As a result, the component 456, which is spring biased, moves in the direction of the arrow 460 into an unlocked position. That is, the protruding end of the component 456 moves upward in the direction of the arrow 460, thereby unlocking the attachment components 120 relative to the attachment components 116 via the opening 462.

The button 450 is coupled to a cam assembly, as shown in FIGS. 4I to 4N, which may be configured to support, guide, and control the cable connection 452 on the left and right sides of the child stroller 100, respectively. Specifically, as shown in FIG. 4L and 4M, the cam assembly 454 may include a pair of symmetrical coupling members 464, 466. For the sake of brevity, FIG. 4N illustrates a perspective view of one of the coupling member which includes three parallel fin plates defining two slots therebetween. A cavity is implemented on all three fin plates for accommodating a shaft, pin or rod that is connected to the proximal end of the cable connection 452. As shown in FIGS. 4J and 4M, the coupling members 464 and 466 collectively define two parallel slots or pockets 468, 470 for supporting, guiding and controlling the cable 452. In response to the actuation of the button 450, the cam assembly 454 pulls the cable connection 452 to effectuate the movements between the attachment components 116 and 120, as described above.

It should be appreciated that the lock/unlock mechanism may be achieved in any suitable way, such as a single interaction point including but not limited to a button, knob, trigger, or lever driving a single lock/unlock mechanism or multiple lock/unlock mechanisms. Alternatively, multiple interactions points (e.g., multiple buttons, knobs, triggers, or levers) may be implemented to control either the single or multiple lock/unlock mechanism(s).

Referring back to FIGS. 1 to 3, in certain embodiments, the basket 112, which may be made of flexible fabric or rigid materials, is fixedly attached to the front wheel assembly 104. The attachment components 116 of the front wheel assembly 104 and the front and back portions 402, 404 of the base frame also form the frame of the basket 112; thus, the basket 111 is likewise expandible in certain embodiments. In an alternative embodiment, the basket 112 may be a separate structure and is detachably placed on the front wheel assembly 104. That is, the front wheel assembly 104 may be pulled out from the basket 112, either individually or linked together.

### Collapsible Lower Adapters and Storage

In accordance with certain aspects, the present disclosure relates to various adapters that may be implemented at a lower or a higher position on the child stroller 100 to permit the connection of different seats and bassinets to be attached to the stroller. Specifically, depending upon the configuration of the child stroller (i.e., a single occupant configuration as shown in FIG. 1 or a double occupant configuration as shown in FIG. 2), adapters located at a lower position of the stroller, such as adapters 130 in FIG. 2, may or may not be used. Stroller users typically place various adapters in the baskets or other compartments associated with the strollers, which leads to adapters being lost or misplaced during storage, transportation, and use of the strollers.

Referring to FIGS. 1, 2, 3, 5A, 5B, 5C, and 5D, a purpose-built storage compartment 114 may be provided for storing and support adapters 130 to reduce the likelihood of misplacement of adapters. In some embodiments, the adapters 130 may be permanently affixed to or, alternatively, releasably attached to the purpose-built storage compartment 114, thereby eliminating the possibility of misplacing adapters. In a preferred embodiment, the purpose-built adapter storage compartment 114 may be located in the front of the child stroller 100, as shown in FIGS. 1, 2, 3, and 5A. It should be appreciated that the exact location, dimension, and construction of the purpose-built storage compartment 114 may depend desired use and specific configuration of the child stroller 100. Alternative locations for storage compartment 111, such as the rear of the child stroller 100, are likewise contemplated herein.

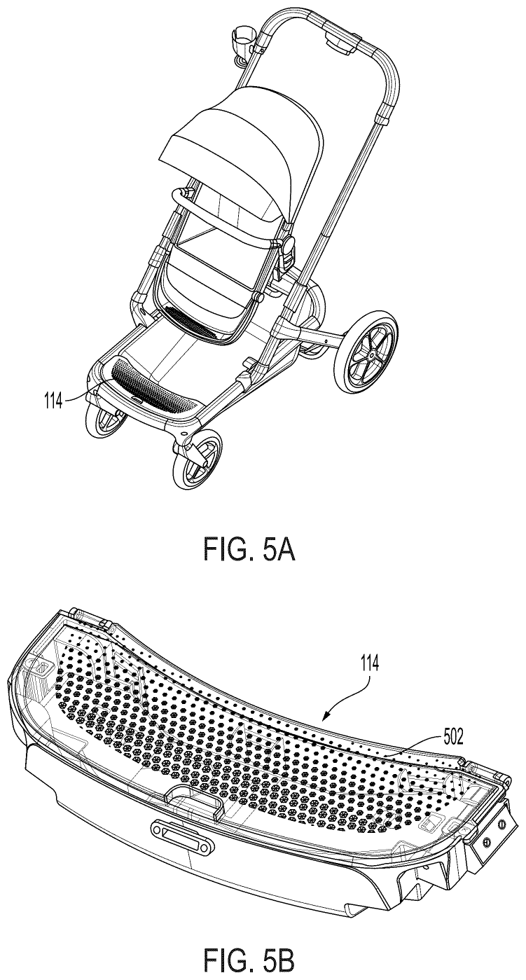

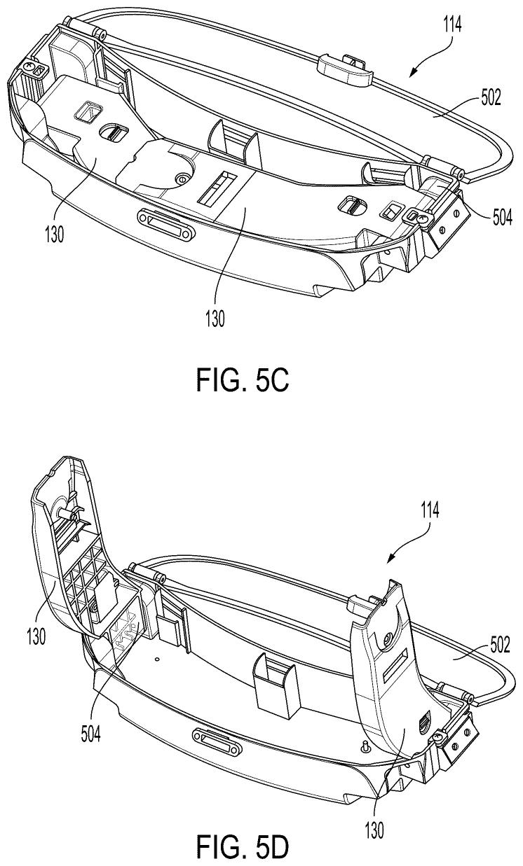

FIGS. 5B to 5D illustrate a purpose-built storage compartment 114 removed from the child stroller 100. A cover 502 may be hinged on the side of the storage compartment 114 and the cover 502 may be transparent, opaque, or semi-transparent. FIG. 5C shows that the cover 502 is an open position exposing a pair of stroller adapters 130 in their stowed position. In this embodiment, the adapters 130 are integrated to the purpose-built storage compartment 114 and can be hingedly deployed from a storage position into a use position via respective pivot connection 504, as shown in FIGS. 5C and 5D. The purpose-built storage compartment 114 may be constructed of flexible and soft materials such as fabrics. In one preferred embodiment, the purpose-built storage compartment 114 may be a rigid structure, made of molded plastic or sheet metal, to provide a number of advantages such as rigidity of structure, resistance to wear, and ease of cleaning and disinfection. Moreover, the cover 502 may be used as a footrest when the stroller adapters 130 are not deployed or in use. In an embodiment, cover 502 has open slots at its sides, to permit closure of cover 502 when the pair of stroller adapters 130 are in the deployed state.

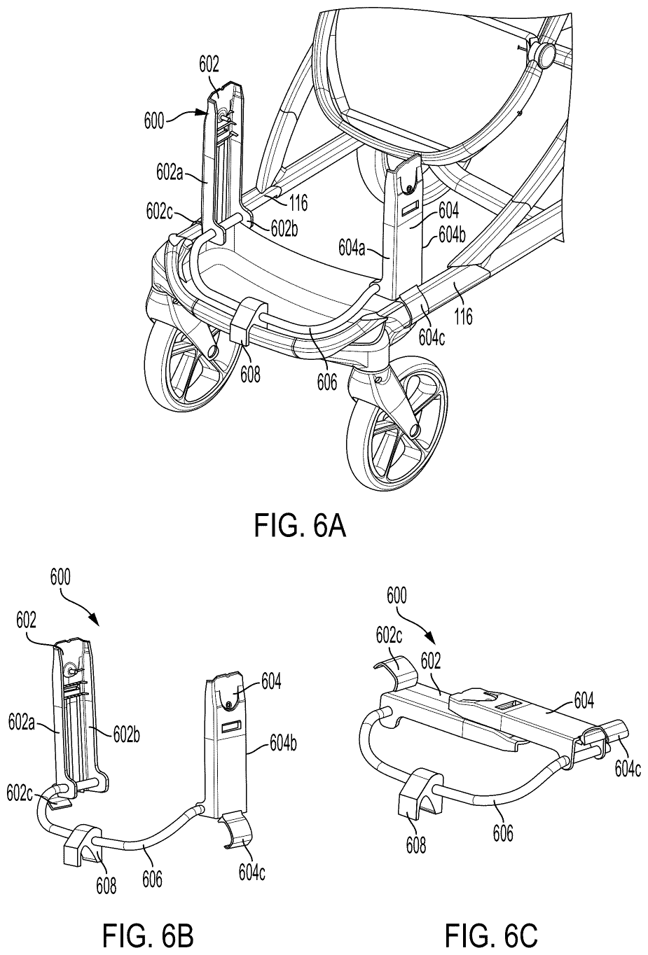

Referring to FIGS. 6A, 6B, and 6C, in accordance with another aspect of the present disclosure, a releasable adapter assembly 600 may generally include adapters 602 and 604, a mounting fixture 606, and at least one retention component 608. Each adapter 602, 604 may have identical shape and dimension including a main planar surface connected with two substantially L-shaped narrow sides 602a, 602b, 604a, 604b, respectively. The mounting fixture 606 may be a substantially U-shaped frame, configured to connect both adapters 602, 604 and releasably attach the adapter assembly 600 to, for example, the front portion 402 of the base frame 400 of the child stroller 100, as shown in FIG. 4A, via the at least one retention component 608.

As further illustrated in FIGS. 6A, 6B, and 6C, in one preferred embodiment, each side leg portion of the U-shaped mounting fixture 606 may connect with each adapter 602, 604 via holes on respective adapter sides 602a, 602b, 604a, 604b to provide a pivot axis. Other suitable pivot coupling mechanism may be implemented as well such as engaging a transversal pin, shaft, rivet or similar elements. As a result, each adapter 602, 604 may rotate about the corresponding side leg portion of the U-shaped mounting fixture 606 and move between a deployed configuration (e.g., FIGS. 6A and 6B) and a folded configuration (e.g., FIG. 6C). To prevent each adapter 602, 604 from loosening the engagement with another detachable apparatus in the deployed configuration, a C-shaped retention component 602c, 604c may be implemented on the bottom edge of each adapter 602, 604 for attachment with each attachment component 116 of the base frame 400 as shown in FIGS. 4A-4F, which may also serve to increase the strength and rigidity of each adapter 602, 604.

It should be appreciated that any suitable detachable means may be used to place and secure the adapter assembly 600 to the child stroller 100. The detachable means may include any means suitable for the purpose of allowing a member to be attached to another member and similarly released, such as quick release and lock mechanisms, snap lock mechanisms, push spring loaded lock buttons, and the like. Further, the retention component 608 may be releasably attached to the mounting fixture 606 and multiple similar or different retention components may be implemented to secure the adapter assembly 600 to the child stroller 100. Namely, in an alternative embodiment, each adapter 602, 604 is pivotable relative to a portion of the front wheel assembly 104 or a portion of each tubular leg member 109A. For example, adapters 602, 604 are telescopic relative to tubular leg members 109A. Alternatively, for example, adapters 602, 604 or rotatable relative to tubular leg members 109A, such as rotatable along a plane parallel to that of tubular leg members 109A. Alternatively, for example, adapters 602, 604 are pivotably hinged relative to tubular leg members 109A, such as rotatable angularly from a plant parallel to that of tubular leg members 109A. In all embodiments, it should be appreciated that adapters 602, 604 could be permanently affixed or, alternatively, removably attached.

### Releasable Adapter Assembly Embodiments

In accordance with additional aspects, the present disclosure relates to adapters that may be implemented at various locations along the two tubular leg members 109A of the lower handlebar assembly 109 on the child stroller 100 to allow the connection of different seats and bassinets to be attached to the stroller, depending upon the configuration of the child stroller, such as a single occupant configuration as shown in FIG. 1 or a double occupant configuration as shown in FIG. 2. Specifically, adapters implemented on the lower handlebar assembly 109 may be at a lower location for a single occupant configuration. However, when in a double occupant configuration, such adapters may be implemented on an upper location on the lower handlebar assembly 109 for stability and center of gravity reasons.

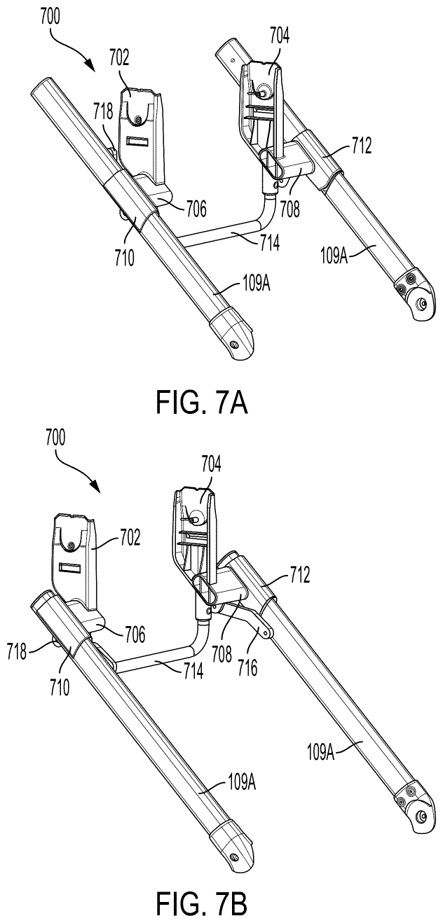

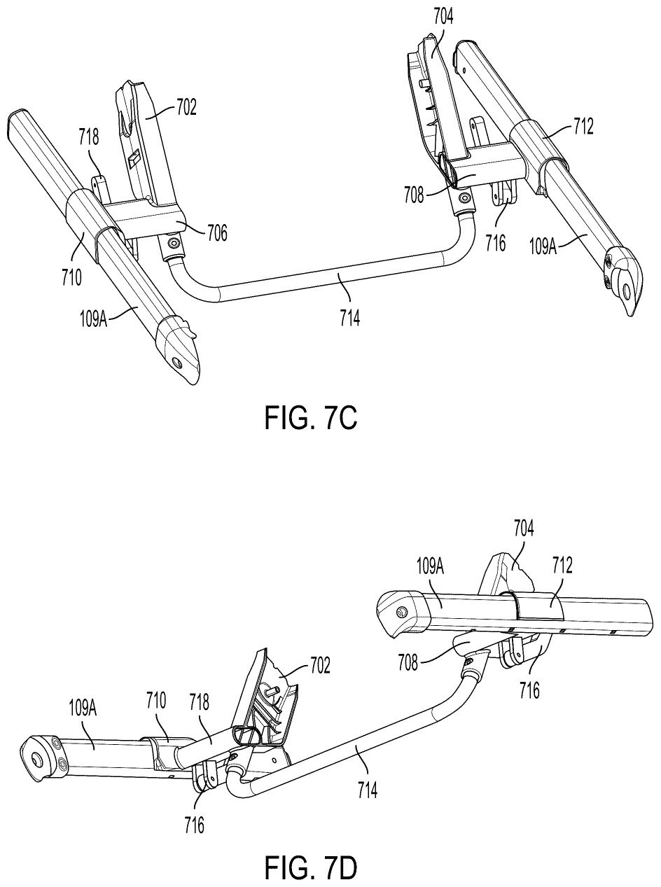

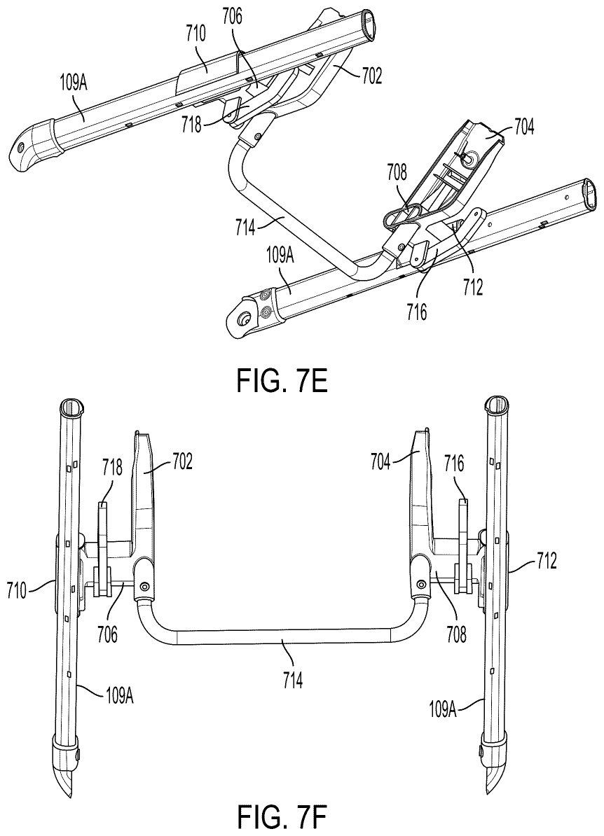

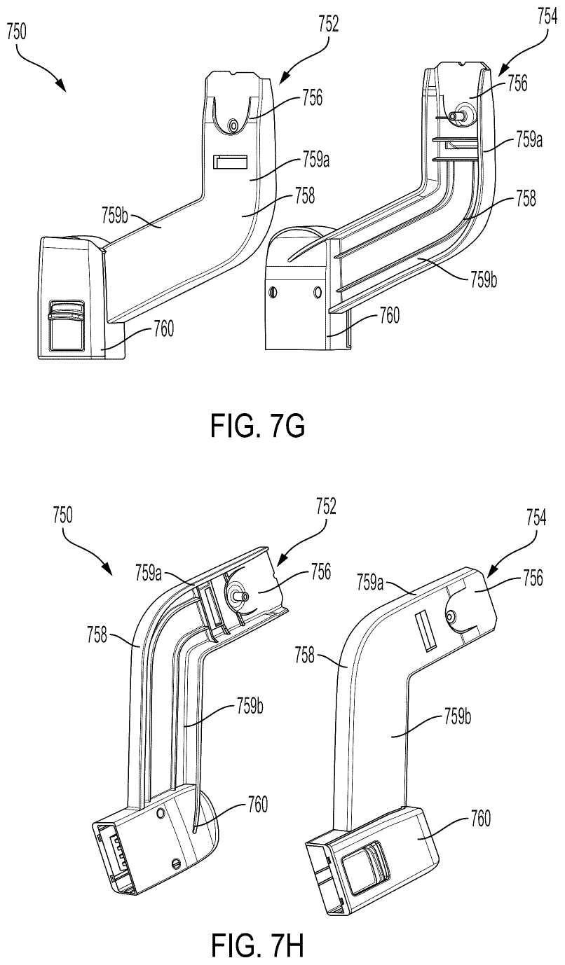

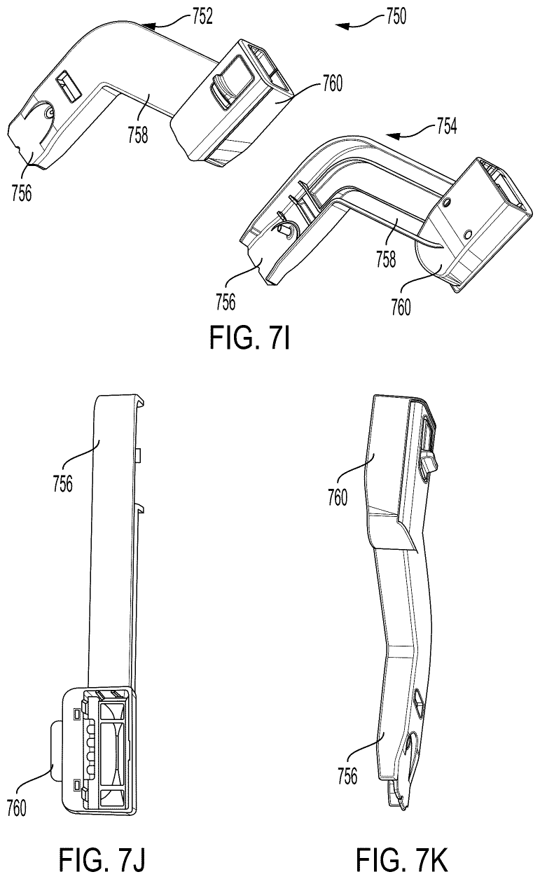

Referring now to FIGS. 7A to 7F, a releasable adapter assembly 700 may be configured to receive the installation of a detachable apparatus at either a lower front position, such as FIG. 7A in a single occupant configuration, or a higher rear position, such as FIG. 7B in a double occupant configuration, on two tubular leg members 109A of the lower handlebar assembly 109.

In some embodiments, the releasable adapter assembly 700 of the present disclosure may generally include a pair of connection members 702, 704, each having a dimension and size configured to engage with a detachable apparatus in different orientations. For example, a detachable child safety seat may be attached to the child stroller 100 via the connection member 702, 704 in a rearward facing position or a forward facing position. The pair of connection members 702, 704 may be connected via a support structure 714 and attached to the inside of the two tubular leg members 109A of the lower handlebar assembly 109 via respective coupling components 706, 708 and mounting fixtures 710, 712. The support structure 714 may extend transversely across the width of the stroller 100 and may be made of a structural load-bearing material, such as steel, and configured to function as a structural element to maintain the structural shape and strength of the stroller for safety during use. In one aspect, each coupling component 706, 708 may respectively include a generally V-shaped pivot link 716, 718 supported by a clevis-type hinge bracket. The pivot link 716, 718 may allow the releasable adapter assembly 700 to connect with another component of the child stroller 100 to facilitate rotational movements therebetween. The pivot feature provided by pivot link 716, 718 is operably coupled to the two tubular leg members 109A of the lower handlebar assembly 109. It should be appreciated that the drawings disclosed herein are only for illustrative purposes and various components of the releasable adapter assembly 700 may be connected via any suitable intermediary parts or members, such as bushings, washers, rivet, and the like, when the adapter assembly 700 is properly installed on the two tubular leg members 109A of the lower handlebar assembly 109.

In some embodiments, the child stroller 100 may include permanent immovable mounting fixtures installed on selected positions on the two tubular leg members 109A of the lower handlebar assembly 109 to receive other accessories and detachable apparatuses (e.g., a child stroller seat, a child safety seat, a pram, a bassinet, or a storage component). There exists a need for further adjusting the position and height of an attached accessory on the stroller. Referring now to FIGS. 7G to 7K, another releasable adapter assembly 750 may be configured to convert a stroller into a customized travel system via a pair of releasable adapters 752, 754. Each adapter may include an engagement member 756 extending upward to engage with a detachable apparatus, a member 760 for locking and/or unlocking each adapter to a set of mounting fixtures installed on selected positions on the two tubular leg members 109A of the lower handlebar assembly 109, and a linkage member 758 for connecting the engagement member 756 and the member 760.

In an embodiment, as shown in FIGS. 7G and 7H, the linkage member 758 may have a substantially dogleg shape including a vertical part 759a and an extension part 759b that is at an angle to the vertical part 759a. The length of the vertical part is selected to position an attached accessory (e.g., a child stroller seat, a child safety seat, a pram, a bassinet, or a storage component) of the stroller in an elevated position without interfering with other parts of the stroller, thereby changing the vertical positioning of the attached accessory. Further, the length of the extension part 759b and the angle between 759a and 759b may be configured to provide a horizontal positioning adjustment to the attached accessory. For example, the angle between parts 759a and 759b may be more than 90 degrees but less than 180 degrees. In a preferred embodiment, the angle may range from 90 degrees to 150 degrees, or more preferably, 90 degrees to 120 degrees. In one aspect, the stroller may be folded while the releasable adapter assembly 750 is attached. It should be appreciated that the member 760 may be implemented with any suitable means such as rotary, sliding, push-button, or pull-trigger.

### Adapter Assembly for Position Adjustment

As disclosed previously, adapters implemented on the lower handlebar assembly 109 of the child stroller 100 may be at a lower location for a single occupant configuration. When in a double occupant configuration, such adapters may be implemented on an upper location on the lower handlebar assembly 109 for stability and center of gravity reasons. Further, position adjustments of a detachable apparatus to a stroller are often useful and convenient for both the child occupant and the parent. For example, changing a child seat height of to a high level may provide a convenient and comfortable seating position for dining at a table in a restaurant or other settings that would otherwise call for a high chair. On the other hand, a lower seat height may allow the child occupant to be near toys or other children at play. Therefore, there exists a need for adjusting positions of a detachable apparatus at a higher position on the child stroller 100, especially when the stroller is in a double occupant configuration.

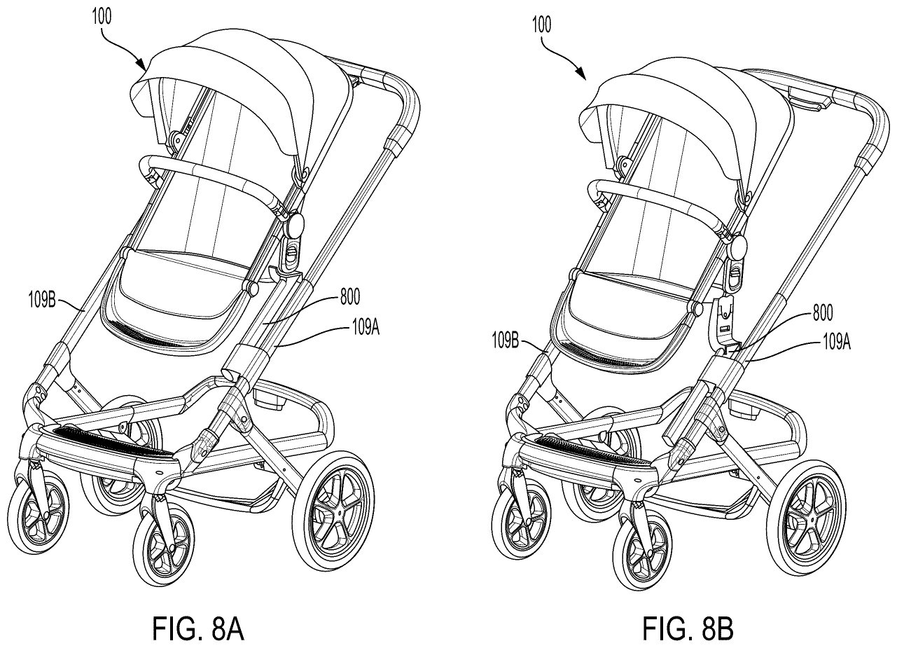

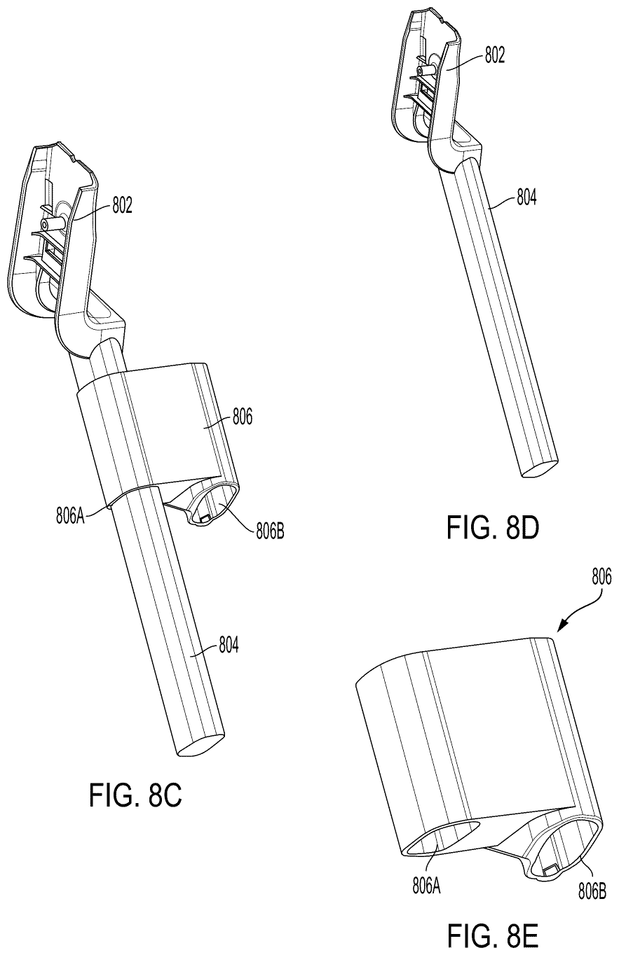

Referring to FIGS. 8A to 8E, at least one adapter assembly 800 may be configured to provide a range of position or height levels to a detachable apparatus at a higher rear position on the child stroller 100. In one aspect, a first adapter assembly 800 may be fixed to a selected location on tubular leg member 109A of the lower handlebar assembly 109, and a second adapter assembly 800 (not pictured) may be fixed to a selected location on tubular leg member 109B. Although not illustrated in the figures, it is contemplated to implement a pair of adapter assemblies 800 on each side of the child stroller 100 to couple with a detachable apparatus with improved stability. For the sake of brevity, only one adapter assembly 800 is illustrated and disclosed herein. The second adapter assembly 800 (not pictured) can be substantially identical to the first adapter assembly 800 with the exception of it being a mirror image of the first adapter assembly 800.

The adapter assembly 800 may move along an axis parallel to the tubular leg members 109A to place a detachable apparatus at a highest position near the upper handlebar assembly 108 of the child stroller 100, as shown in FIG. 8A, or a lowest position near the front of the child stroller 100, as shown in FIG. 8B. During use, the user of the child stroller 100 may attach and secure an adapter (not shown) at a selected position, such as the highest position or the lowest position as shown in FIGS. 8A and 8B, on the opposite tubular leg members 109A of the lower handlebar assembly 109, adjust the adapter of the assembly 800 to be at the same height, and attach the detachable apparatus to the child stroller 100 via corresponding coupling components of the adapter and the adapter assembly 800.

Referring to FIGS. 8C to 8E, the adapter assembly 800 may include a connection member 802 having a dimension and size configured to engage with a detachable apparatus in different orientations. For example, a detachable child safety seat may be attached to the child stroller via the connection member 802 in a rearward facing position or a forward facing position. The connection member 802 may be connected and supported by an elongated body 804 which slides axially upward or downward via a channel 806A provided by a mounting fixture 806. The elongated body 804 extends generally parallel to the tubular leg members 109A of lower handlebar assembly 109, and may be disposed at an inner side of a selected tubular leg member 109A. In certain embodiments, the elongated body 804 may have a thickness that is at least equal to the thickness of the side frame 102. The connection member 802 and the elongated body 804 may be integrally formed, or releasably attached to each other. In one embodiment, the mounting fixture 806 may have two sleeve channels 806A, 806B for receiving the elongated body 804 and the side frame 102 of the child stroller 100, respectively. As shown in FIGS. 8A and 8B, the mounting fixture 806 may be fixed to one tubular leg member 109A at a selected position via its sleeve channel 806B. It should be appreciated that the mounting fixture 806 may have different constructions to couple with the elongated body 804 and the tubular leg member 109A including but not limited to a strap, a bracket, bots, pins, or via another mounting components or fasteners.

The adapter assembly 800 of the present disclosure advantageously provides different position levels while maintaining a secure and stable seating arrangement for the child occupant. In various embodiments, only one of two adapter assemblies 800 can be employed to sufficiently support the detachable apparatus.

In some embodiments, the adapter assembly 800 may additionally include locking mechanisms (not shown) to maintain the connection member 802 a desired seat height level. For example, the outer surface of the elongated body 804 and/or the interior surface of the channel 806A of the mounting fixture adapter assembly 800 may include retainers, such as pins, guides, posts, inserts, and the like, to minimize or prevent relative movements therebetween (axial movement and rotation movements) once the detachable apparatus is installed on the child stroller 100 via the adapter assembly 800 at a desired height level. Such locking mechanisms can synchronize the movement of the seat supports, prevent relative displacement, assist or control the height adjustment, and prevent accidental abrupt drops in seat level.

In an alternative embodiment, the adapter assembly 800 may include a pair of adapters (as shown in FIG. 8C) similar in construction and respectively installed and coupled to the child stroller 100 to receive a detachable apparatus.

### Extendable and Retractable Handle

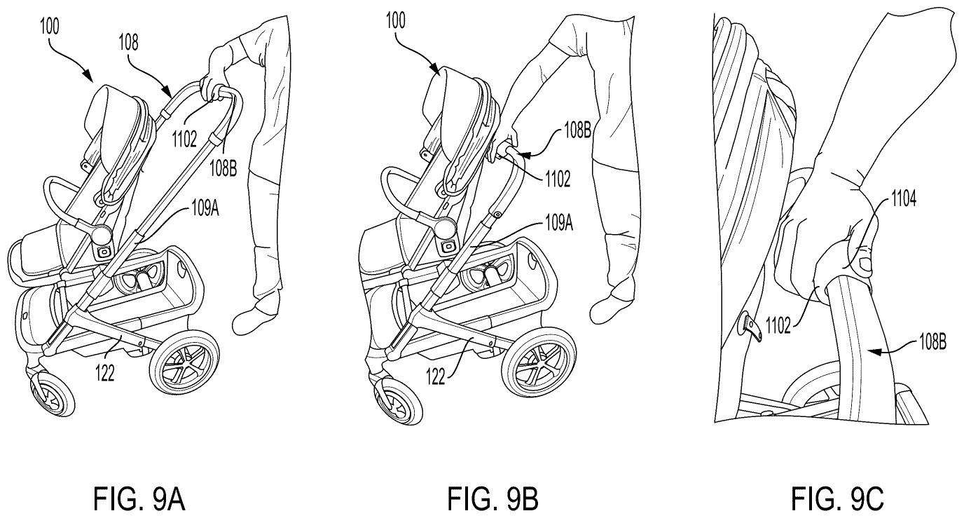

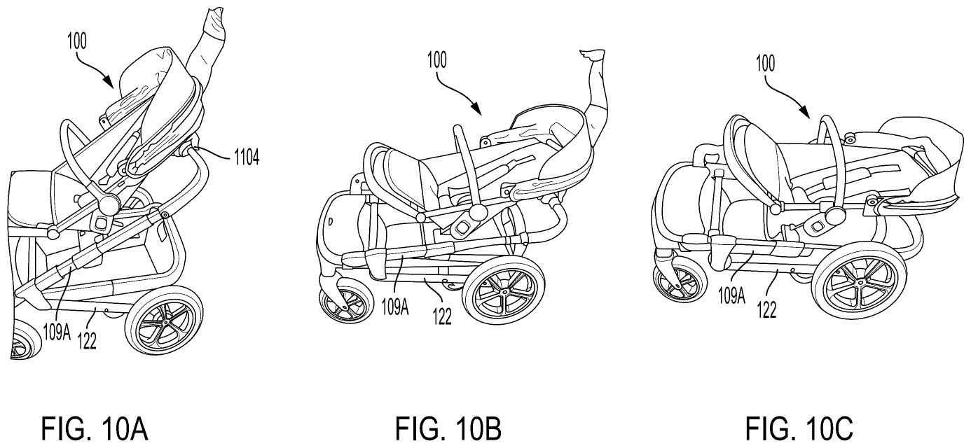

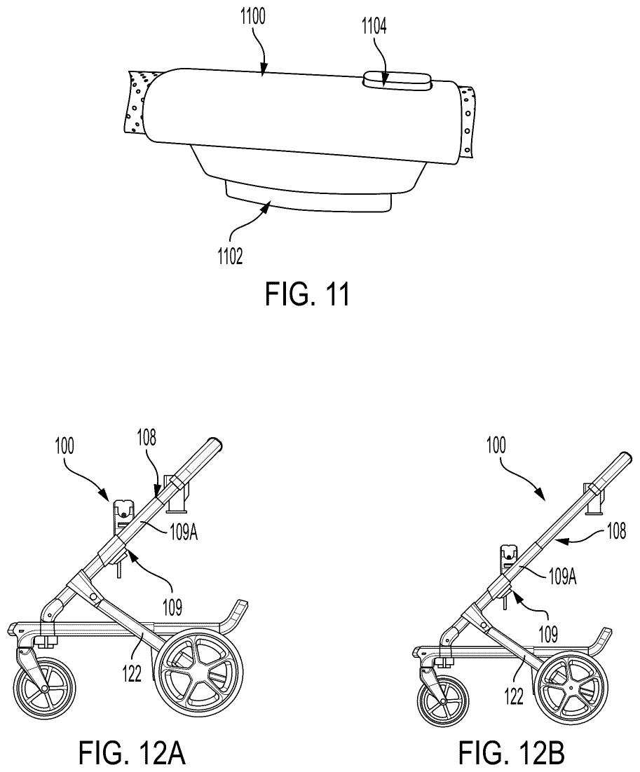

Referring to FIGS. 9A to 11, in accordance with important aspects of the present disclosure, the child stroller 100 may be conveniently collapsed and folded for storage by a user via two sequential steps. In an embodiment, a control module 1100, as shown in FIG. 11, may be implemented on the handle grip 108B of the upper handlebar assembly 108. A first button 1102 of the control module 1100 may be actuated to allow the upper handlebar assembly 108 of the child stroller 100 to telescope in and out of the rest of the stroller frame, as shown in FIGS. 9A, 9B, 12A and 12B. Subsequently, once the upper handlebar assembly 108 telescopes far enough into the stroller frame, a second button 1104 of the control module 1100 may be simultaneously actuated to allow the user to collapse the stroller frame, as shown in FIGS. 10A, 10B, and 10C.

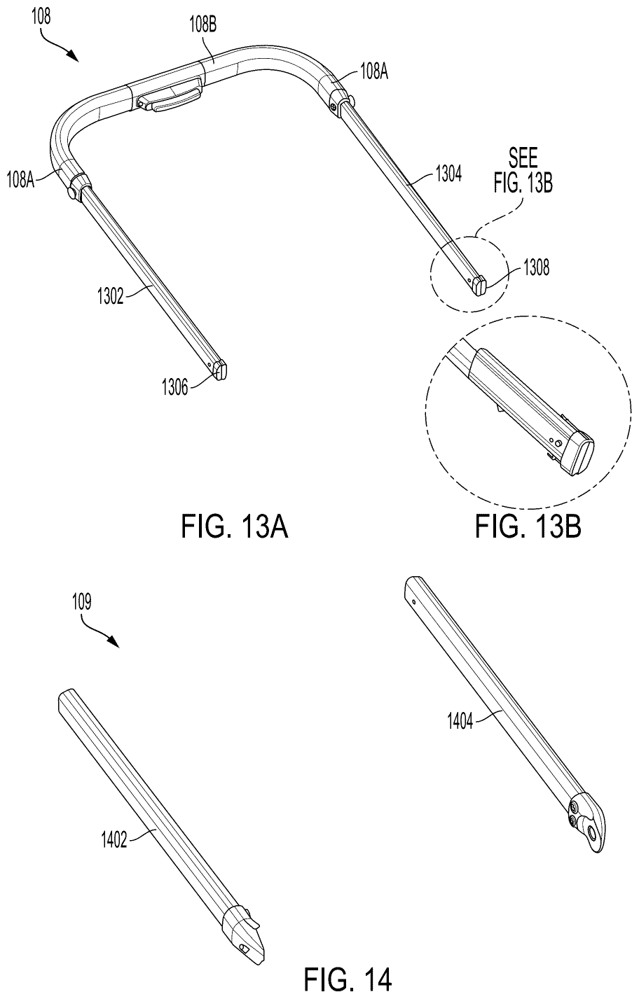

Referring to FIGS. 13A to 14, in accordance with aspects of the present disclosure, an upper handlebar assembly 108 and a lower handlebar assembly 109 are respectively shown, disassembled from each other. The upper handlebar assembly 108 may include two side portions 108A respectively disposed at a left and a right side of the child stroller 100, and a handle grip 108B connected with the two side portions 108A, thereby forming a generally U-shaped handle portion for a user to push and pull. A pair of tubular members 1302, 1304 may extend axially downward from the side portions 108A to insert into corresponding tubular leg members 1402, 1406 of the lower handlebar assembly 109, respectively. At the distal end of each tubular member 1302, 1304, sub-assemblies 1306, 1308 may be implemented to control (e.g., lock and unlock) telescoping heights of the upper handlebar assembly 108 and unlock a hinge associated with the rear leg frames 122 to facilitate folding of the stroller frame when the first and second buttons 1102, 1104 of the control module 1100 are simultaneously actuated, as will be described fully below.

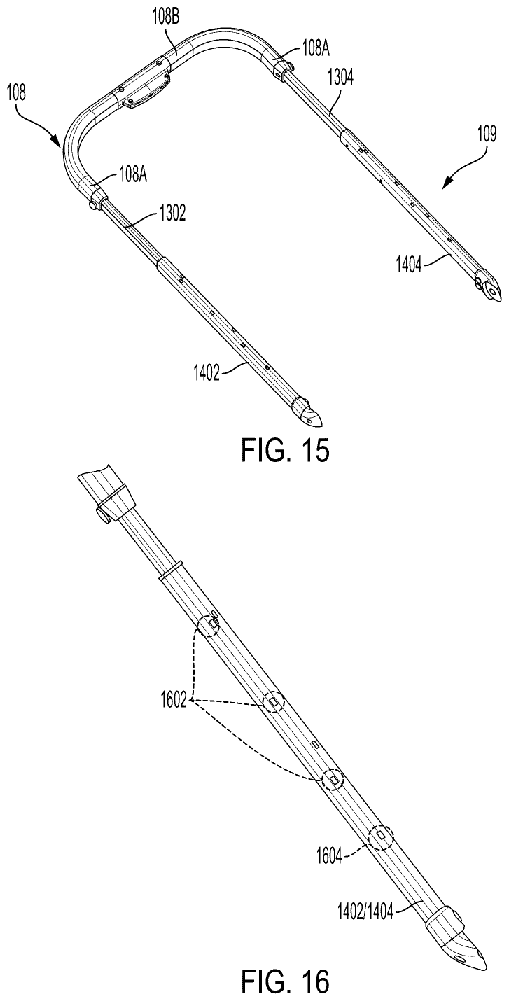

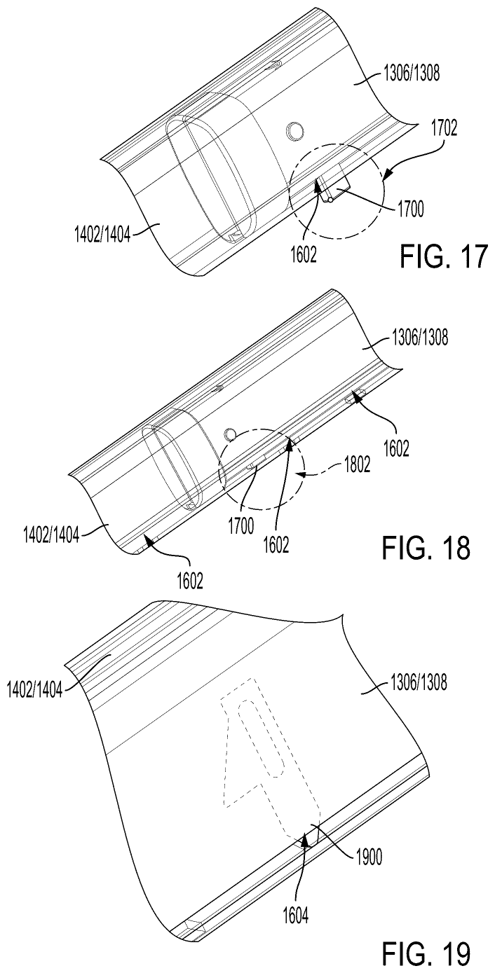

FIG. 15 shows an assembled view of the upper handlebar assembly 108 and a lower handlebar assembly 109 where the two tubular member 1302, 1304 of the upper handlebar assembly 108 are inserted into the respective tubular leg members 1402, 1404 of the lower handlebar assembly 109. In one preferred embodiment, as shown in FIG. 16, a plurality of holes 1602, such as three holes, may be implemented on each tubular leg member 1402, 1404 of the lower handlebar assembly 109 to provide multiple degrees of extension and retraction as a user pushes/pulls and controls the child stroller 100 via the control module 1100 of FIG. 11. Referring to FIGS. 17 and 18, the sub-assemblies 1306, 1308 implemented on the distal end of each tubular member 1302, 1304 may include a component 1700 configured to lock and unlock the upper handlebar assembly 108 into different telescoping heights.

For example, in response to detecting that the user of the child stroller 100 actuates the button 1102 of the control module 1100 and moves the upper handlebar assembly 108 in or out of the stroller frame, the component 1700 may move into and engage with one of the plurality of holes 1602 implemented on each tubular leg member 1402, 1404 of the lower handlebar assembly 109, thereby locking the upper handlebar assembly 108 to the lower handlebar assembly 109 at a selected locked position 1702, such as a position of one of the plurality of holes 1602, as shown in FIG. 17. On the other hand, the component 1700 may be in a unlocked position 1802 as the upper handlebar assembly 108 continues sliding upward or downward along the interior wall of each tubular leg member 1402, 1404 until the component 1700 lines up with the next corresponding hole 1602 to engage with when the button 1102 of the control module 1100 is released.

Referring to FIGS. 16 and 19, near the distal end of each tubular leg member 1402, 1404 of the lower handlebar assembly 109, an additional hole 1604 (the lowest hole on each tubular leg member 1402, 1404) is provided to receive another component 1900 implemented in the sub-assemblies 1306, 1308 of each tubular member 1302, 1304. As will be described fully below, the component 1900 may be configured to move into and engage with hole 1604 to actuate a leg hinge locking plate, such that the stroller frame can be collapsed when the second button 1104 of the control module 1100 is actuated.

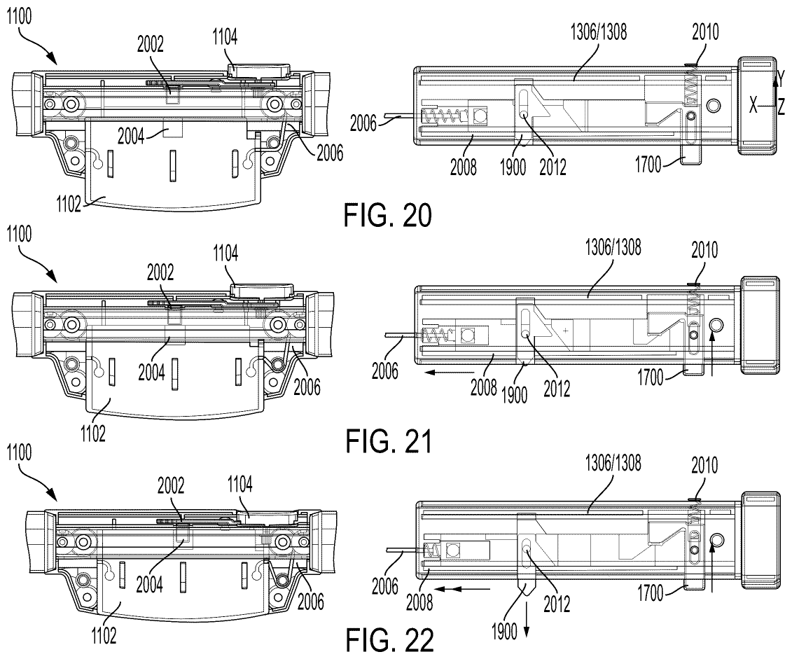

In accordance with aspects of the present disclosure, FIGS. 20 to 24 illustrate a two-step handle collapsing and stroller folding process via the control module 1100 of FIG. 11. Specifically, the left view of FIG. 20 shows unactuated states of the control module 1100 including the first button (handle collapsing) 1102, the second button (stroller folding) 1104, a limiter 2002, a limiter slot 2004 implemented on the first button 1120, and a cable connection 2006. The right view of FIG. 20 shows the original states of each sub-assembly 1306, 1308 including a cam 2008 coupled with a cable connection 2006, a first component 1700 for adjusting the upper handlebar assembly 108 into different telescoping heights, and a second component 1900 for controlling the rear leg frames 122 for the purposes of folding the child stroller 100. The component 1900 may be retained within each sub-assembly 1306, 1308 via a pin 2012.

As shown in FIGS. 18 and 21, when the button 1102 of the control module 1100 is actuated, an internal cable 2006 pulls the cam 2008 of each sub-assembly 1306, 1308 axially upward. As a result, the component 1700, which is spring biased, moves into an unlocked position due to the contraction of the spring 2010. In the meantime, the limiter 2002 blocks any downward movement of the button 1104 when the button 1104 is not actuated, resulting that the component 1900 is free floating in this position and only the upper handlebar assembly 108 can move among different telescoping heights provided by the plurality of holes 1602.

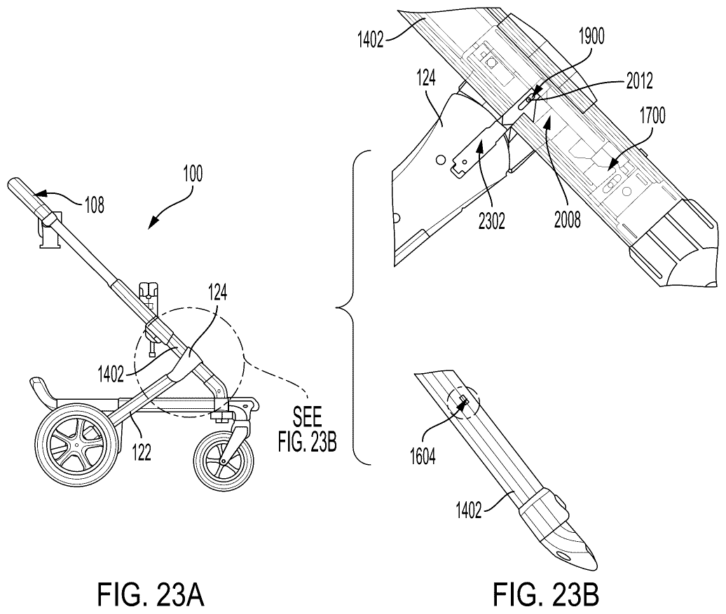

Once the upper handlebar assembly 108 telescopes far enough into the stroller frame, such as passing the lowest hole among holes 1602 and approaching and engaging with hole 1604, as shown in FIG. 16, and the user of the child stroller 100 simultaneously actuates both buttons 1102 and 1104 of the control module 1100, the limiter 2002 rotates and moves into the limiter slot 2004, thereby allowing a downward movement of the button 1104, as shown in FIG. 22. The internal cable 2006 pulls the cam 2008 of each sub-assembly 1306, 1308 axially upward further in response to the actuation of both buttons 1102 and 1104, resulting that the pin 2012 moves from a retention state to a release state, forcing the component 1900 to project out of hole 1604 to actuate a component 2302 implemented in the connection component 124, as shown in FIGS. 23A to 23B. Specifically, the actuation of the component 2302 unlocks a hinge associated with the rear leg frames 122 to allow each leg frame to pivot about the connection component 124, thereby collapsing the stroller frame into a folded position, as shown in FIGS. 10A, 10B and 10C.

### Folding Mechanism

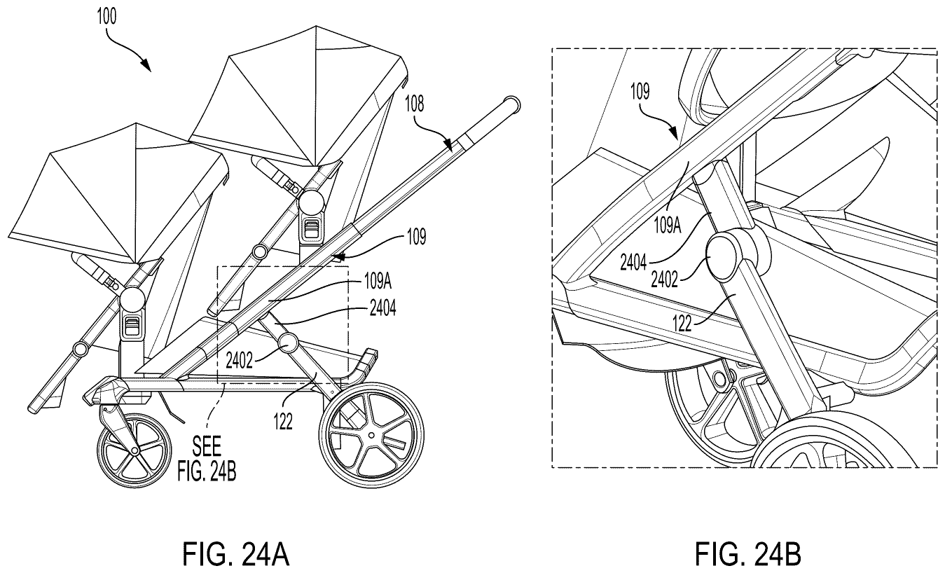

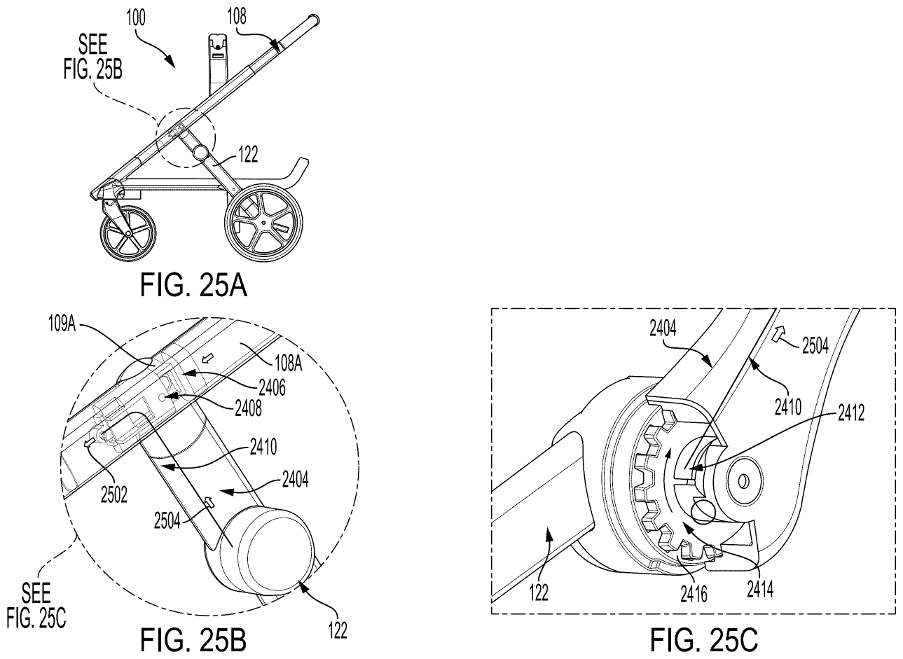

In accordance with additional aspects of the present disclosure, referring to FIGS. 24A to 30, the child stroller 100 may be conveniently collapsed and folded for storage in response to detecting that a user pushes down the upper handlebar assembly 108 via different folding structures. In one embodiment, as shown in FIGS. 24A to 24B, each rear leg frame 122 of the child stroller 100 may be configured to connect with each tubular leg member 109A of the lower handlebar assembly 109 via a hinge component 2402 and a linkage component 2404. As disclosed above with respect to FIGS. 9A to 10C, the upper handlebar assembly 108 may be configured to telescope in and out the lower handlebar assembly 109. When a user pushes down the upper handlebar assembly 108 for collapsing the stroller 100, as shown in FIGS. 25A to 25C, a distal end 2406 of each side portion 108A of the upper handlebar assembly 108 extends axially downward into a corresponding tubular leg member 109A of the lower handlebar assembly 109. Further, one distal end of the linkage component 2404 may be coupled with each tubular leg member 109A to collectively house a cable 2410. In some embodiments, the cable 2410 may be configured to wrap around a rotating block 2410 of the linkage component 2404 and pass through the linkage component 2404 to attach with a slider component 2408 implemented within each tubular leg member 109A. When the slider component 2408 moves in the direction of arrow 2502 due to the axial downward movement of the upper handlebar assembly 108, the attachment between the cable 2410 and the slider component 2408 generates a force to pull the cable 2410 upward (i.e., in the direction of arrow 2504). As a result, the rotating block 2412 with the cable 2410 wrapped around starts rotating which in turn makes a hinge gear 2414 push downward to unlock the stroller frame. In certain embodiments, the hinge gear 2414 may have a peripheral edge of a circular shape provided with first plurality of teeth respectively engaged with second plurality of teeth of a corresponding coupling member 2416.

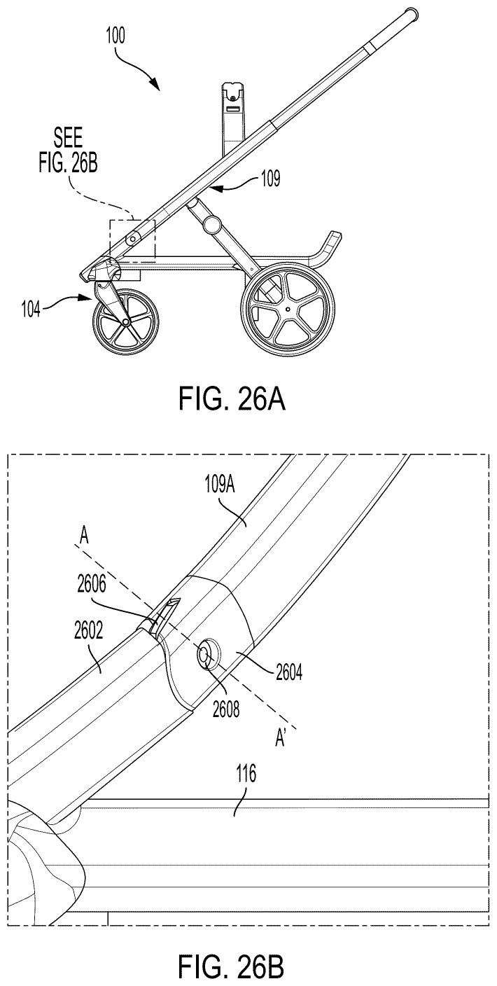

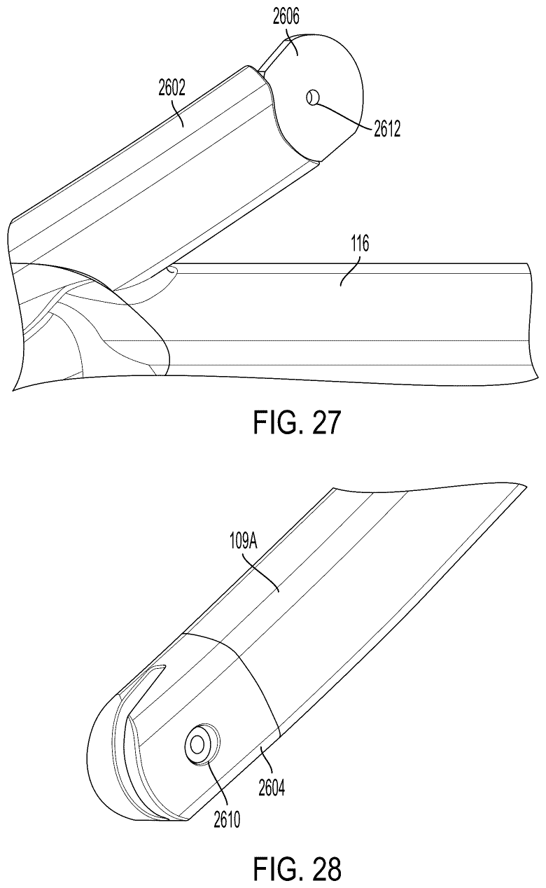

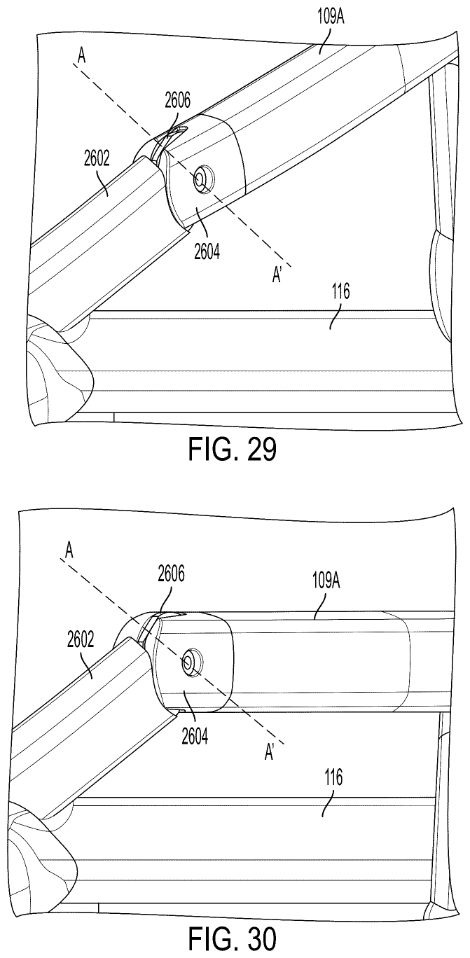

Referring now to FIGS. 26A to 30, a pivot connection may be implemented to facilitate folding and unfolding of the child stroller 100, in accordance with aspects of the present disclosure. In one embodiment, as shown in FIGS. 26A to 26B, the front wheel assembly 104 of the child stroller 100 may include a front frame portion 2602 that extends at an angle to the horizontal attachment component(s) 116 to provide a structural support to such a pivot connection formed by, for example, components 2604 and 2606. Specifically, as shown in FIG. 27, an inner plate portion 2606, which is made of metal or rigid materials, may be implemented on a distal end of the front frame portion 2602. The inner plate portion 2606 may fit slidably between a pair of spaced flanges of a coupling component 2604 implemented on a distal end of each tubular leg member 109A of the lower handlebar assembly 109. In one aspect, each tubular leg member 109A may be anchored to the front frame portion 2602 and the horizontal attachment component(s) 116 by a rivet 2608 through apertures 2610 implemented on the pair of flanges which also passes through a hole 2612 of the inner plate portion 2606. As a result, components 2604 and 2606 are pivotally coupled to or hinged together by the rivet 2608 along a pivot axis AA′ via aligned rivet apertures/holes 2610 and 2612. It should be appreciated that any suitable pivot connection may be implemented such as shaft, pin or the like to allow components 2604 and 2606 to rotate relative to each other about the pivot axis AA′. In some embodiments, no locking structure is implemented on the pivot connection. As shown in FIGS. 27 and 28, the lower handlebar assembly 109 may pivot about the pivot axis AA′ to various positions to facilitate folding and unfolding of the child stroller 100. Specifically, as shown in FIG. 29, the tubular leg member 109A of the lower handlebar assembly 109 may start pivoting about the axis AA′ during a stroller folding process and is eventually collapsed to the position to be parallel with the horizontal attachment component(s) 116, as shown in FIG. 30, when the stroller is in a fully folded state.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced otherwise than specifically described without departing from the scope and spirit of the present disclosure. Thus, embodiments of the present disclosure should be considered in all respects as illustrative and not restrictive. It will be evident to the annotator skilled in the art to freely combine several or all of the embodiments discussed here as deemed suitable for a specific application of the disclosure. Throughout this disclosure, terms like “advantageous”, “exemplary” or “preferred” indicate elements or dimensions which are particularly suitable (but not essential) to the disclosure or an embodiment thereof, and may be modified wherever deemed suitable by the skilled annotator, except where expressly required. Accordingly, the scope of the invention should be determined not by the embodiments illustrated, but by the appended claims and their equivalents.

The terms “a,” “an,” “the” and similar referents used in the context of describing the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this present disclosure are described herein, including the best mode known to the inventors for carrying out the present disclosure. Of course, variations on these described embodiments will become apparent to those of ordinary skill in the art upon reading the foregoing description. The skilled artisans are expected to employ such variations as appropriate. Accordingly, this present disclosure includes all modifications and equivalents of the subject matter recited in the claims appended hereto as permitted by applicable law. Moreover, any combination of the above-described elements in all possible variations thereof is encompassed by the present disclosure, unless otherwise indicated herein or otherwise clearly contradicted by context.

1. A collapsible stroller, comprising:
an upper handlebar assembly;
a lower handlebar assembly connected to the upper handlebar assembly;
a pair of rear leg frames pivotally connected with the lower handlebar assembly on a left side and a right side of the stroller, respectively; and
a control module configured to extend or retract the upper handlebar assembly in relation to the lower handlebar assembly via a first control mode, and further configured to collapse the pair of rear leg frames with respect to the lower handlebar assembly via a second control mode.

2. The collapsible stroller of claim 1, wherein the upper handlebar assembly includes a generally U-shaped handle portion and two tubular members extend axially downward from two side portions of the U-shaped handle portion.

3. The collapsible stroller of claim 2, wherein the lower handlebar assembly includes two tubular leg members configured to respectively receive the two tubular members of the upper handlebar assembly.

4. The collapsible stroller of claim 3, wherein a distal end of each tubular member of the upper handlebar assembly is connected with a sub-assembly, wherein the sub-assembly includes a first component configured to control relative movements between the upper and lower handlebar assemblies, and a second component configured to collapse the pair of rear leg frames with respect to the lower handlebar assembly.

5. The collapsible stroller of claim 4, wherein each tubular leg member of the lower handlebar assembly includes a plurality of holes configured to engage with the first component and the second component.

6. The collapsible stroller of claim 5, wherein, in response to detecting that the first control mode is activated, the control module is configured to move the first component into an unlocked position, such that the upper handlebar assembly moves relative to the lower handlebar assembly.

7. The collapsible stroller of claim 5, wherein the first control mode is deactivated when the first component engage with one of the plurality of holes on each tubular leg member of the lower handlebar assembly, thereby locking the upper handlebar assembly to the lower handlebar assembly at a selected position.

8. The collapsible stroller of claim 7, wherein, in response to detecting that the first component is engaged with a lowest hole on each tubular leg member of the lower handlebar assembly and the second control mode is activated, the control module is configured to force the second component to project out the lowest hole in order to unlock a hinge associated with the pair of rear leg frames.

9. The collapsible stroller of claim 8, wherein the hinge is activated to allow the pair of rear leg frames to pivot about a connection component coupled with the lower handlebar assembly, thereby collapsing the pair of rear leg frames with respect to the lower handlebar assembly.

10. The collapsible stroller of claim 1, wherein the second control mode of the control module only activates when the first component is engaged with the lowest hole on each tubular leg member of the lower handlebar assembly.

11. A collapsible stroller, comprising:
an upper handlebar assembly;
a lower handlebar assembly connected to the upper handlebar assembly;
a pair of rear leg frames pivotally connected with the lower handlebar assembly on a left side and a right side of the stroller, respectively; and
a control module having a first button and a second button, the control module configured to extend or retract the upper handlebar assembly in relation to the lower handlebar assembly via a the first button.

12. The collapsible stroller of claim 11, wherein the upper handlebar assembly includes a generally U-shaped handle portion and two tubular members extend axially downward from two side portions of the U-shaped handle portion.

13. The collapsible stroller of claim 12, wherein the lower handlebar assembly includes two tubular leg members configured to respectively receive the two tubular members of the upper handlebar assembly.

14. The collapsible stroller of claim 13, wherein a distal end of each tubular member of the upper handlebar assembly is connected with a sub-assembly, wherein the sub-assembly includes a first component configured to control relative movements between the upper and lower handlebar assemblies, and a second component configured to collapse the pair of rear leg frames with respect to the lower handlebar assembly.

15. The collapsible stroller of claim 14, wherein each tubular leg member of the lower handlebar assembly includes a plurality of holes configured to engage with the first component and the second component.

16. The collapsible stroller of claim 15, wherein, in response to detecting that the first button is activated, the control module is configured to move the first component into an unlocked position, such that the upper handlebar assembly moves relative to the lower handlebar assembly.

17. The collapsible stroller of claim 15, wherein the first button is deactivated when the first component engage with one of the plurality of holes on each tubular leg member of the lower handlebar assembly, thereby locking the upper handlebar assembly to the lower handlebar assembly at a selected position.

18. The collapsible stroller of claim 17, further configured to collapse the pair of rear leg frames with respect to the lower handlebar assembly via the second button,
wherein, in response to detecting that the first component is engaged with a lowest hole on each tubular leg member of the lower handlebar assembly and the second button is activated, the control module is configured to force the second component to project out the lowest hole in order to unlock a hinge associated with the pair of rear leg frames.

19. The collapsible stroller of claim 18, wherein the hinge is activated to allow the pair of rear leg frames to pivot about a connection component coupled with the lower handlebar assembly, thereby collapsing the pair of rear leg frames with respect to the lower handlebar assembly.

20. The collapsible stroller of claim 11, wherein the second button of the control module only activates when the first component is engaged with the lowest hole on each tubular leg member of the lower handlebar assembly.
